(19) United States
(12) Patent Application Publication
(10) Pub. No.: US 2026/0142395 A1
(43) Pub. Date: May 21, 2026

(54) HIGH-SPEED, EASY-MAINTENANCE CONNECTOR AND INTERCONNECTION SYSTEM THEREOF

(71) Applicant: Amphenol Commercial Products (Chengdu) Co., Ltd., Chengdu (CN)

(72) Inventors: Xiangjun He, Chengdu (CN); Chao Zou, Chengdu (CN); Yaohua Hou, Chengdu (CN); Lei Liao, Shenzhen (CN)

(73) Assignee: Amphenol Commercial Products (Chengdu) Co., Ltd., Chengdu (CN)

(21) Appl. No.: 19/396,157

(22) Filed: Nov. 20, 2025

(30) Foreign Application Priority Data
Nov. 21, 2024 (CN) 202411676252.6
Nov. 21, 2024 (CN) 202411676300.1
Nov. 21, 2024 (CN) 202411676428.8
Nov. 21, 2024 (CN) 202422849560.6
Nov. 21, 2024 (CN) 202422850326.5
Nov. 21, 2024 (CN) 202422850356.6
Nov. 21, 2024 (CN) 202422850435.7
Nov. 21, 2024 (CN) 202422850499.7
Nov. 21, 2024 (CN) 202422850516.7

(51) Int. Cl. H01R 12/78; H01R 12/70; H01R 12/77

(52) U.S. Cl. CPC H01R 12/78; H01R 12/7011; H01R 12/774

(57) ABSTRACT

High-speed, easily maintained connectors and interconnection systems. An interconnection system includes a cable connector and a board connector that can mate with each other. The cable connector includes a housing and a flexible flat cable with a mating portion in the housing. The housing includes a conductive layer on an insulating body. The flexible flat cable includes a shielding layer electrically connected to the housing conductive layer. The board connector includes a main housing holding terminals, a cage outside the main housing, and an outer housing outside the cage. The cage can be electrically connected to the cable shielding layer through the housing conductive layer. An elastic conductive member can be disposed around the cable connector housing to facilitate interconnection between the cage and the housing conductive layer. Such techniques can enable high-speed, easy maintenance connectors and interconnection systems for harsh environments such as one presented by an automobile.

### CROSS-REFERENCE TO RELATED APPLICATIONS

This application claims priority to and the benefit of Chinese Patent Application No. 202422850326.5, filed on Nov. 21, 2024. This application also claims priority to and the benefit of Chinese Patent Application No. 202411676252.6, filed on Nov. 21, 2024. This application also claims priority to and the benefit of Chinese Patent Application No. 202422849560.6, filed on Nov. 21, 2024. This application also claims priority to and the benefit of Chinese Patent Application No. 202422850356.6, filed on Nov. 21, 2024. This application also claims priority to and the benefit of Chinese Patent Application No. 202411676300.1, filed on Nov. 21, 2024. This application also claims priority to and the benefit of Chinese Patent Application No. 202422850435.7, filed on Nov. 21, 2024. This application also claims priority to and the benefit of Chinese Patent Application No. 202422850516.7, filed on Nov. 21, 2024. This application also claims priority to and the benefit of Chinese Patent Application No. 202422850499.7, filed on Nov. 21, 2024. This application also claims priority to and the benefit of Chinese Patent Application No. 202411676428.8, filed on Nov. 21, 2024. The contents of these applications are incorporated herein by reference in their entirety.

### TECHNICAL FIELD

The present disclosure generally relates to electrical electronic system, such as those including electrical connectors, used to interconnect electronic assemblies.

### BACKGROUND

Electrical connectors are used in many electronic systems. It is generally easier and more cost effective to manufacture an electronic system as separate electronic assemblies, which may be joined together with electrical connectors. Electrical connectors may be used for interconnecting assemblies so that the assemblies may operate together as part of an electronic system. Electrical connectors, for example, may be mounted onto printed circuit boards within two assemblies that are connected by mating the electrical connectors. In other electronic systems, it may be impractical to join two printed circuit boards by directly mating electrical connectors on these printed circuit boards. For example, these printed circuit boards may be spaced so far apart in assembled electronic systems that the electrical connectors mounted in the boards cannot be directly connected.

In the electronic systems, assemblies may be interconnected through cables. The cables may be terminated with connectors that can mate with connectors mounted on printed circuit boards. In this way, the assemblies may be interconnected by plugging electrical connectors that are part of cable assemblies into electrical connectors mounted onto printed circuit boards. In other electronic system architectures, an electrical connector terminated to a cable may be mated with another electrical connector terminated to another cable.

Modern automobiles are examples of electronic systems with assemblies interconnected through cables. For example, the automobiles may include electronic control units (ECUs) for controlling various automotive systems, such as engines, transmission control units (TCUs), security systems, emission control systems, lighting systems, advanced driver assistance systems (ADASs), entertainment systems, navigation systems and cameras. The ECUs may be manufactured as separate assemblies that are interconnected by one or more cables routed between the assemblies. To simplify manufacturing, an assembly may include a cable terminated with an electrical connector, which can be mated to a complementary electrical connector that is either terminated to another cable or attached to a circuit board within another assembly.

### SUMMARY

Aspects of the present disclosure relate to high-speed, easy-maintenance connectors and interconnection systems thereof.

Some embodiments relate to an electrical connector. The electrical connector may comprise a housing comprising an insulating body and a conductive layer extending from an inner surface to an outer surface of the insulating body; and a flexible flat cable comprising a mating portion held in the housing and having one or more contact pads, and a shielding layer spaced from the one or more contact pads and adjacent a portion of the conductive layer on the inner surface of the insulating body of the housing such that the shielding layer of the flexible flat cable is electrically connected to the conductive layer of the housing.

Optionally, the electrical connector comprises a conductive member disposed on the housing and adjacent the conductive layer on the outer surface of the insulating body of the housing such that the conductive member is electrically connected to the shielding layer of the flexible flat cable through the conductive layer of the housing.

Optionally, the conductive member is elastic.

Optionally, the housing comprises a groove recessed from the outer surface; and the conductive member is disposed in and protrude out of the groove of the housing.

Optionally, the conductive member comprises conductive rubber.

Optionally, the housing comprises a first inner surface and a second inner surface facing each other; the flexible flat cable is a first flexible flat cable comprising a first mating portion held in the housing and having one or more first contact pads, and a first shielding layer spaced from the one or more first contact pads and adjacent the conductive layer on the first inner surface of the insulating body of the housing; and the electrical connector comprises a second flexible flat cable comprising a second mating portion held in the housing and having one or more second contact pads, and a second shielding layer spaced from the one or more second contact pads and adjacent the conductive layer on the second inner surface of the insulating body of the housing.

Optionally, the housing comprises a first housing portion and a second housing portion together enclosing a channel; and the electrical connector comprises a spacer disposed in the channel of the housing and fixedly holding the first mating portion of the first flexible flat cable and the second mating portion of the second flexible flat cable on opposite sides of the spacer.

Optionally, the first shielding layer and the second shielding layer comprise aluminum foil.

Optionally, the electrical connector comprises a conductive member encircling the channel, and disposed on the housing and adjacent the conductive layer on the outer surface of the insulating body of the housing such that the conductive member is electrically connected to the first and second shielding layers of the first and second flexible flat cables through the conductive layer of the housing.

Optionally, the housing comprises a locking feature configured to receive a connector position assurance; and the conductive member is disposed between the locking feature and the mating portion of the flexible flat cable.

Some embodiments relate to an electrical connector. The electrical connector may comprise a connector housing comprising a supporting portion at a mating end; and at least one cable assembly, each of the at least one cable assembly comprising a flexible flat cable comprising a mating portion having one or more contact pads, the mating portion disposed on the supporting portion of the connector housing, and an assembly housing held in the connector housing and holding the flexible flat cable at a location spaced from the mating portion, the assembly housing comprising one or more beams protruding toward the flexible flat cable.

Optionally, for each of the at least one cable assembly: the flexible flat cable is a first flexible flat cable comprising a first mating portion having one or more first contact pads; the cable assembly comprises a second flexible flat cable comprising a second mating portion having one or more second contact pads, and a spacer disposed in the assembly housing and between the first and second flexible flat cables; and the first and second mating portions are disposed on opposite sides of the supporting portion.

Optionally, the assembly housing comprises one or more first beams protruding from a top wall toward the first flexible flat cable, and one or more second beams protruding from a bottom wall toward the second flexible flat cable.

Optionally, the one or more first beams and the one or more second beams protrude toward each other.

Optionally, the at least one cable assembly comprises a first cable assembly configured for signal transmission; and a second cable assembly configured for power supply.

Optionally, the mating portion of the first flexible flat cable of the first cable assembly comprises a plurality of first contact pads; the mating portion of the second flexible flat cable of the first cable assembly comprises a plurality of second contact pads; the mating portion of the first flexible flat cable of the second cable assembly comprises a single third contact pad; and the mating portion of the second flexible flat cable of the second cable assembly comprises a single fourth contact pad.

Optionally, the connector housing comprises an opening at a bottom; and a terminal position assurance disposed in the opening at the bottom of the connector housing, the terminal position assurance comprises one or more arms extending into the connector housing and engaging the assembly housing of the at least one cable assembly.

Optionally, the connector housing comprises a locking feature at a top, the locking feature configured to receive a connector position assurance.

Some embodiments relate to an electrical connector. The electrical connector may comprise a main housing; a plurality of conductive elements held by the main housing; a cage disposed outside the main housing and comprising a front portion extending beyond the main housing in a mating direction; and an outer housing attached to the cage and extending beyond the cage in the mating direction, the outer housing comprising a locking feature configured to engage a complementary locking feature of a mating connector and a connector position assurance.

Optionally, the main housing comprises a socket; the plurality of conductive elements comprise mating contact portions in the socket of the main housing, and contact tails extending out of the main housing and configured to mount to a circuit board; and a gap between the cage and the main housing, the gap configured to receive a portion of a housing of a mating connector such that the cage is electrically connected to a conductive layer of the housing of the mating connector.

Some embodiments relate to a cable connector. The cable connector may comprise a housing, at least one flexible flat cable, and a conductive member. The housing may comprise an insulating body and a conductive layer disposed on a surface of the insulating body. The at least one flexible flat cable each may comprise an end portion held within the housing, and a shielding layer, which may be disposed on a surface of the at least one flexible flat cable. The conductive member may be disposed at a mating end of the housing configured to mate with a complementary electrical connector and may protrude from a mating surface of the mating end configured to interface with a shielding shell of the complementary electrical connector. The conductive member may be electrically connected to the conductive layer.

Optionally, the shielding layer may be electrically connected to the conductive layer.

Optionally, the conductive layer may comprise an outer conductive layer disposed on an outer surface of the insulating body and an inner conductive layer disposed on an inner surface of the insulating body. The conductive member may be mounted to the outer surface of the insulating body and in electrical contact with the outer conductive layer. The shielding layer may be electrically connected to the inner conductive layer. The inner conductive layer may be electrically connected to the outer conductive layer.

Optionally, the conductive layer may completely cover surfaces of the insulating body.

Optionally, the at least one flexible flat cable may include a first flexible flat cable and a second flexible flat cable. Each of the first flexible flat cable and the second flexible flat cable may comprise an inner surface and an outer surface opposite to the inner surface. The inner surfaces of the first flexible flat cable and the second flexible flat cable may face to each other.

The shielding layer may comprise an outer shielding layer disposed on the outer surface of at least one of the first flexible flat cable and the second flexible flat cable. The outer shielding layer may be electrically connected to the conductive layer.

Optionally, the shielding layer may further comprise an inner shielding layer disposed on the inner surface of at least one of the first flexible flat cable and the second flexible flat cable.

Optionally, the end portion of each of the at least one flexible flat cable may be electrically connected with or comprise contact pads configured to be in electrical connection with a complementary electrical connector. The outer shielding layer may extend forward to front ends of the contact pads of a corresponding flexible flat cable.

Optionally, the inner shielding layer may be in electrical contact with the outer shielding layer.

Optionally, at least a portion of each of the inner shielding layer and the outer shielding layer may be wider than a corresponding flexible flat cable, and widened portions of the inner shielding layer and the outer shielding layer may be electrically connected to each other.

Optionally, the conductive member may comprise a conductive ring.

Optionally, the conductive ring is elastic.

Optionally, the insulating body may comprise a top housing portion and a bottom housing portion. The top housing portion and the bottom housing portion define a mounting channel.

The end portion of each of the at least one flexible flat cable may be held within the mounting channel.

Optionally, the at least one flexible flat cable may comprise a first flexible flat cable and a second flexible flat cable that are stacked. A separator may be held within the mounting channel and clamped between the first flexible flat cable and the second flexible flat cable.

Some embodiments relate to an electronic system. The electronic system may comprise a cable connector and a board connector. The cable connector may comprise a first housing, a first conductive assembly held by the first housing, and a first shielding assembly. The board connector may comprise a second housing, a second conductive assembly held by the second housing, and a second shielding assembly. When the cable connector mates with the board connector, the first conductive assembly may in electrical contact with the second conductive assembly, and the first shielding assembly and the second shielding assembly may form a fully enclosed shielding at a periphery of the first conductive assembly and the second conductive assembly.

Optionally, the first shielding assembly may comprise an outer conductive layer disposed on an outer surface of the first housing and a conductive ring sleeved over the first housing. The second shielding assembly may comprise a shielding shell held by the second housing. The conductive ring may be electrically connected between the outer conductive layer and the shielding shell when the cable connector mates with the board connector.

Optionally, the first conductive assembly may comprise a flexible flat cable. A shielding layer may be disposed on a surface of the flexible flat cable. The first shielding assembly may comprise the shielding layer and an inner conductive layer disposed on an inner surface of the first housing. The shielding layer may be in electrical contact with the inner conductive layer.

Optionally, a separator may be disposed in the first housing. An end of the first conductive assembly may be mounted to the separator. A first annular cavity may be formed between the separator and the first housing. The first annular cavity may surround the end of the first conductive assembly. The second housing may comprise a main housing. The second conductive assembly may be held by the main housing. A front portion of the main housing may be inserted into the first annular cavity. The second conductive assembly may be electrically connected to the end of the first conductive assembly.

Optionally, a second annular cavity may be formed between the second shielding assembly and the main housing. The first housing may be inserted into the second annular cavity, such that the first shielding assembly may be electrically connected to the second shielding assembly.

Optionally, the second shielding assembly may surround at least a portion of the main housing. The second housing may further comprise an outer housing disposed outside the second shielding assembly. The outer housing may comprise a second locking feature configured to lock with the cable connector.

Some embodiments relate to a cable connector. The cable connector may comprise a housing, a plurality of flexible flat cables that are stacked, and a separator clamped between end portions of adjacent flexible flat cables. The housing may include a mating end, a connecting end, and a mounting channel extending from the connecting end to the mating end. End portions of the plurality of flexible flat cables may be inserted into the mounting channel from the connecting end and extend to the mating end. The end portions of the plurality of flexible flat cables and the separator may be held within the housing.

Optionally, a shielding layer may be formed on a surface of each of the plurality of flexible flat cables.

Optionally, the plurality of flexible flat cables may include a first flexible flat cable and a second flexible flat cable. Each of the first flexible flat cable and the second flexible flat cable may comprise an inner surface and an outer surface opposite to the inner surface. The inner surfaces of the first flexible flat cable and the second flexible flat cable may face to each other.

The shielding layer may comprise an inner shielding layer disposed on an inner surface of at least one of the first flexible flat cable and the second flexible flat cable. The inner shielding layer may extend forward to an end portion of a corresponding flexible flat cable.

Optionally, the plurality of flexible flat cables may comprise a first flexible flat cable and a second flexible flat cable. Each of the first flexible flat cable and the second flexible flat cable may comprise an inner surface and an outer surface opposite to the inner surface. The inner surfaces of the first flexible flat cable and the second flexible flat cable may face to each other.

The shielding layer may comprise an outer shielding layer disposed on an outer surface of at least one of the first flexible flat cable and the second flexible flat cable. The outer shielding layer may be spaced apart from a front end of an end portion of a corresponding flexible flat cable such that ends of cable conductors of the corresponding flexible flat cable are exposed to form contact pads.

Optionally, the housing may comprise an inner conductive layer on an inner surface thereof. The outer shielding layer may be in electrical contact with the inner conductive layer.

Optionally, the mounting channel may comprise a first channel portion accommodating the separator and a second channel portion behind the first channel portion. Along a stacking direction of the plurality of flexible flat cables, the size of at least a portion of the second channel portion may be smaller than the combined size of the end portions of the plurality of flexible flat cables and the separator. The inner wall of the second channel portion may abut against the plurality of flexible flat cables, such that the inner conductive layer is in electrical contact with the outer shielding layer.

Optionally, each of the plurality of flexible flat cables may comprise an inner surface and an outer surface opposed the inner surface. The shielding layer may comprise an inner shielding layer disposed on the inner surface and an outer shielding layer disposed on the outer surface.

For each of the plurality of flexible flat cables: at least a portion of each of the inner shielding layer and the outer shielding layer may be wider than a corresponding flexible flat cable, and widened portions of the inner shielding layer and the outer shielding layer may be electrically connected to each other.

Optionally, the housing may comprise an outer conductive layer on an outer surface thereof.

Optionally, a conductive member may be disposed at the mating end and in electrical contact with the outer conductive layer. The conductive member may protrude from an outer surface of the mating end.

Optionally, the conductive member may comprise a conductive ring.

Optionally, the conductive ring is elastic.

Optionally, the housing may further comprise an inner conductive layer on an inner surface thereof. The inner conductive layer may be electrically connected to the outer conductive layer.

Optionally, a shielding layer may be formed on a surface of each of the plurality of flexible flat cables. The shielding layer may be electrically connected to the inner conductive layer.

Optionally, for each of the plurality of flexible flat cables: the separator may comprise a first groove and a second groove, the first groove and the second groove extend along a length direction of a corresponding flexible flat cable and are opposite along a width direction of the corresponding flexible flat cable; and the two side edges of the corresponding flexible flat cable may be respectively inserted into the first groove and the second groove.

Optionally, for each of the plurality of flexible flat cables: the separator may comprise a flange disposed at a front end thereof and extending along a width direction of a corresponding flexible flat cable, and the corresponding flexible flat cable may be disposed behind the flange and abut against a rear surface of the flange; and the flange may be higher than contact pads of the corresponding flexible flat cable.

Optionally, along a direction of the flange protruding from the separator, the rear surface of the flange may be inclined rearward.

Optionally, the housing may comprise a top housing portion and a bottom housing portion opposite to the top housing portion along the stacking direction of the plurality of flexible flat cables. The separator and the plurality of flexible flat cables may be clamped between the top housing portion and the bottom housing portion.

Optionally, side edges of the end portions of the plurality of flexible flat cables may comprise cable lugs, and side edges of the separator may comprise separator lugs. The housing may restrict the positions of the cable lugs and the separator lugs at least along the length direction and stacking direction of the plurality of flexible flat cables.

Optionally, the cable lugs and the separator lugs may be aligned along the length direction of the plurality of flexible flat cables.

Optionally, one of the top housing portion and the bottom housing portion may comprise a projection, and the other of the top housing portion and the bottom housing portion may comprise an engaging portion. The projection may be engaged with the engaging portion, so that the top housing portion is fixed to the bottom housing portion.

Optionally, the separator may be clamped between the top housing portion and the bottom housing portion, and may divide a front part of the mounting channel into a first mounting sub-channel and a second mounting sub-channel. The first mounting sub-channel and the second mounting sub-channel may receive end portions of respective flexible flat cables.

The first mounting sub-channel may be formed between the separator and the top housing portion; and the second mounting sub-channel may be formed between the separator and the bottom housing portion.

Optionally, at least one of the top housing portion and the bottom housing portion may comprise a positioning slot. The separator may comprise a first positioning pin protruding along an assembling direction of the top housing portion with the bottom housing portion. The first positioning pin may be inserted into the positioning slot to position the separator along a length direction and width direction of the mounting channel.

Optionally, a gap may be disposed between the housing and an adjacent shielding layer along a stacking direction of the plurality of flexible flat cables.

Optionally, each of the plurality of flexible flat cables may comprise a first cable portion disposed on the separator, a second cable portion located outside the housing, and a third cable portion joining the first cable portion and the second cable portion. The housing may be spaced apart from a portion of an adjacent shielding layer on the first cable portion of an adjacent flexible flat cable along the stacking direction. A portion of the mounting channel accommodating the third cable portions of the plurality of flexible flat cables may have a size larger than a combined size of the plurality of flexible flat cables along the stacking direction.

Some embodiments relate to a method for manufacturing a cable connector. The method may comprise: attaching an end portion of a first flexible flat cable to a first side of a separator; assembling the separator with the first flexible flat cable attached thereto to a bottom housing portion, with the first side facing the bottom housing portion; attaching an end portion of a second flexible flat cable to a second side of the separator opposite to the first side; and assembling a top housing portion to the bottom housing portion such that the separator may be clamped between the top housing portion and the bottom housing portion.

Optionally, the top housing portion may comprise a first locking feature configured to cooperate with a connector position assurance.

Optionally, the method may further comprise: sleeving a conductive ring onto the assembled top housing portion and bottom housing portion.

Some embodiments relate to an electronic system. The electronic system may comprise a cable connector mentioned above and a complementary electrical connector mateable to a mating end of the cable connector.

Some embodiments relate to a cable assembly. The cable assembly may comprise: an housing having a top wall and a bottom wall; a first flexible flat cable and a second flexible flat cable that are stacked and held between the top wall and the bottom wall and a separator clamped between the first flexible flat cable and the second flexible flat cable. A tail of an end portion of each of the first flexible flat cable and the second flexible flat cable may include a contact pad.

The housing may surround end portions of the first flexible flat cable and the second flexible flat cable with contact pads of the first flexible flat cable and the second flexible flat cable exposed outside the housing.

Optionally, the first flexible flat cable may be adjacent to the top wall, and the second flexible flat cable may be adjacent to the bottom wall. The top wall may comprise top wall clamping portions protruding toward the first flexible flat cable, and the bottom wall may comprise bottom wall clamping portions protruding toward the second flexible flat cable. The first flexible flat cable and the second flexible flat cable may be clamped between the top wall clamping portions and the bottom wall clamping portions along a stacking direction of the first flexible flat cable and the second flexible flat cable.

Optionally, each of the first flexible flat cable and the second flexible flat cable may include a substrate, a cable conductor formed on the substrate, and an insulating layer covering the cable conductor. The insulating layer may expose a portion of the cable conductor on a tail of an end portion of a corresponding flexible flat cable to form the contact pad. The top wall clamping portions may include first top wall clamping portions. Side edges of the first flexible flat cable may be clamped between the separator and the first top wall clamping portions, and the side edges of the first flexible flat cable include no cable conductor. The bottom wall clamping portion may include first bottom wall clamping portions. Side edges of the second flexible flat cable may be clamped between the separator and the first bottom wall clamping portions, and the side edges of the second flexible flat cable include no cable conductor.

Optionally, the first top wall clamping portions and the first bottom wall clamping portions may be configured to rigidly apply forces to the first flexible flat cable and the second flexible flat cable, respectively.

Optionally, the housing may have two ends opposite along a length direction of the first flexible flat cable and the second flexible flat cable. Both the first top wall clamping portions and the first bottom wall clamping portions may be disposed at each of the two ends.

Optionally, each of the first flexible flat cable and the second flexible flat cable may include a substrate, a cable conductor formed on the substrate, and an insulating layer covering the cable conductor. The insulating layer may expose a portion of the cable conductor on a tail of an end portion of a corresponding flexible flat cable to form the contact pad. The top wall clamping portions may include a second top wall clamping portion, and a central portion of the first flexible flat cable may be clamped between the separator and the second top wall clamping portion. The bottom wall clamping portions may include a second bottom wall clamping portion, and a central portion of the second flexible flat cable may be clamped between the separator and the second bottom wall clamping portion.

Optionally, the second top wall clamping portion and the second bottom wall clamping portion may be configured to apply elastic forces to the first flexible flat cable and the second flexible flat cable, respectively.

Optionally, the second top wall clamping portion may include a beam extending from the top wall and abutting against the first flexible flat cable. The second bottom wall clamping portion may include a beam extending from the bottom wall and abutting against the second flexible flat cable.

Optionally, the second top wall clamping portion and the second bottom wall clamping portion may be located at the middle portions of the housing in a width direction of the first flexible flat cable and the second flexible flat cable.

Optionally, the housing may include a first housing portion and a second housing portion. The first housing portion may include the top wall and first side walls. The first side walls may extend from the top wall toward the bottom wall and be opposite to each other along a width direction of the first flexible flat cable and the second flexible flat cable. The second housing portion may include the bottom wall and second side walls. The second side walls may extend from the bottom wall toward the top wall and be opposite to each other along the width direction. The first side walls may be connected to the second side walls to limit the positions of the first flexible flat cable and the second flexible flat cable along the width direction.

Optionally, side edges of each of the first flexible flat cable and the second flexible flat cable may comprise first notches. At least portions of the first side walls and the second side walls may be engaged with the first notches to limit the positions of the first flexible flat cable and the second flexible flat cable along a length direction of the first flexible flat cable and the second flexible flat cable.

Optionally, the first side walls may be connected to the second side walls through features.

Optionally, the at least a portion of the first side walls may be connected with the at least a portion of the second side walls through features.

Optionally, the first side walls may include first inner parts and first outer parts arranged along the length direction. The second side walls may include second inner parts and second outer parts arranged along the length direction. The first inner parts and the second inner parts may be staggered along the length direction, and may clamp the first flexible flat cable and the second flexible flat cable along the width direction. The first outer parts and the second outer parts may be staggered along the length direction, and may clamp the second inner parts and the first inner parts along the width direction, respectively.

Optionally, each of the first inner parts and the second inner parts may include an inner middle sub-part and an inner end sub-part. The inner middle sub-part may be engaged with a corresponding first notch. The inner end sub-part may be located outside the corresponding first notch. Each of the first outer parts and the second outer parts may include an outer middle sub-part and an outer end sub-part. The outer middle sub-part may abut against an outer side of an inner middle sub-part, and the outer end sub-part may abut against an outer side of an inner end sub-part.

Optionally, for each of the first outer parts and the second outer parts: a rib may be provided on an outer surface of the outer middle sub-part. The rib may be spaced apart from an outer end sub-part of a corresponding outer part to form a gap for receiving a terminal position assurance.

Optionally, for each of the first housing portion and the second housing portion, a snap-fitting feature may be provided on an outer surface of the inner middle sub-part, and a snap-fitting opening may be provided in the outer middle sub-part. The snap-fitting feature of the first housing portion may be engaged with the snap-fitting opening of the second housing portion, and the snap-fitting feature of the second housing portion may be engaged with the snap-fitting opening of the first housing portion.

Optionally, about an axis of the cable assembly parallel to the width direction, the first inner parts may be symmetrical to the second inner parts, and the first outer parts may be symmetrical to the second outer parts.

Optionally, side edges of the separator may comprise second notches. At least portions of the first side walls and the second side walls may be engaged with the second notches to limit the position of the separator along the length direction.

Optionally, the first housing portion may be configured to structurally be identical to the second housing portion.

Optionally, projections of side surfaces of the separator in a horizontal plane may fall onto projections of side surfaces of the first flexible flat cable and the second flexible flat cable in the horizontal plane.

Optionally, the cable assembly may include a first type cable assembly and a second type cable assembly. Each of the first type cable assembly and the second type cable assembly may include the housing, the first flexible flat cable, the second flexible flat cable, and the separator. Each of the first flexible flat cable and the second flexible flat cable of the second type cable assembly may include a plurality of cable conductors, an insulating layer, and a shielding layer. The plurality of cable conductors may extend along a length direction of the first flexible flat cable and the second flexible flat cable. The insulating layer may cover the plurality of cable conductors but exposing ends of the plurality of cable conductors on a tail of an end portion of a corresponding flexible flat cable to form contact pads. The shielding layer may cover the insulating layer.

Some embodiments relate to a cable connector. The cable connector may comprise a connector housing having a mating portion and at least one cable assembly held by the connector housing. Each of the at least one cable assembly may include an housing, as well as a first flexible flat cable and a second flexible flat cable that are stacked. A tail of an end portion of each of the first flexible flat cable and the second flexible flat cable may include a contact pad extending to the mating portion of the connector housing. The housing may surround end portions of the first flexible flat cable and the second flexible flat cable. The contact pads of the first flexible flat cable and the second flexible flat cable may be exposed outside the housing.

The housing may be held in the connector housing.

Optionally, the mating portion may include a supporting portion. The supporting portion may have a first surface and a second surface opposite to each other along a stacking direction of the first flexible flat cable and the second flexible flat cable. A first groove and a second groove may be respectively recessed from the first surface and the second surface. The tail of the first flexible flat cable may be positioned in the first groove. The contact pad of the first flexible flat cable may face an opening of the first groove. The tail of the second flexible flat cable may be positioned in the second groove. The contact pad of the second flexible flat cable may face an opening of the second groove.

Optionally, a pair of side walls of the first groove opposite to each other along a width direction of the first flexible flat cable may comprise third grooves, and two side edges of the tail of the first flexible flat cable may be respectively inserted into the third grooves.

Optionally, a pair of side walls of the second groove opposite to each other along a width direction of the second flexible flat cable may comprise fourth grooves, and two side edges of the tail of the second flexible flat cable may be respectively inserted into the fourth grooves.

Optionally, each of the at least one cable assembly may include a separator. The separator may be held in the housing and clamped between the first flexible flat cable and the second flexible flat cable. A portion of the supporting portion between the first groove and the second groove may have a thickness equal to that of the separator.

Optionally, the connector housing may further include a mounting portion opposite to the mating portion along a length direction of the first flexible flat cable and the second flexible flat cable. The housing may be mounted into the connector housing from the mounting portion. The cable connector may further include a terminal position assurance connected to the connector housing, and the housing may be positioned by the mating portion of the connector housing and the terminal position assurance along the length direction.

Optionally, a bottom wall of the connector housing may comprise a mounting hole communicating with an inner cavity of the connector housing. An outer side surface of the housing may include a gap extending along a stacking direction of the first flexible flat cable and the second flexible flat cable. The terminal position assurance may be inserted into the gap through the mounting hole to position the housing.

Optionally, the at least one cable assembly may include a first cable assembly and a second cable assembly. The first cable assembly may be configured for signal transmission, and the second cable assembly may be configured for power supply.

Optionally, for each of the at least one cable assembly, a rib extending along a length direction of the first flexible flat cable and the second flexible flat cable may be provided on an inner surface of the connector housing. The rib may be embedded into the housing of a corresponding cable assembly.

Some embodiments relate to a board connector. The board connector may comprise a housing, a plurality of conductive terminals held by the housing, a cage surrounding the housing along a circumferential direction of the plurality of conductive terminals, and an outer housing surrounding the cage along the circumferential direction.

Optionally, the board connector may be applied in an electronic system having the cable connector as mentioned above, and the board connector may be mated to the cable connector.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of a portion of an electronic system comprising a cable connector and a board connector, shown as mated with each other, according to some embodiments.

FIG. 1B is a cross-sectional perspective view of the electronic system shown in FIG. 1A.

FIG. 2 is a perspective view of the electronic system shown in FIG. 1A, with the cable connector and the board connector shown separated from each other.

FIG. 3 is an exploded perspective view of the cable connector shown in FIG. 1A.

FIG. 4A is a cross-sectional perspective view of the cable connector shown in FIG. 3, taken along a longitudinal central plane.

FIG. 4B is a cross-sectional view corresponding to FIG. 4A.

FIG. 4C is a cross-sectional view of an alternative embodiment of the cable connector shown in FIG. 4A.

FIG. 5 is a cross-sectional perspective view of the cable connector shown in FIG. 3, taken along a plane offset to the right relative to the longitudinal central plane.

FIGS. 6A and 6B are perspective views of a top housing portion of the cable connector shown in FIG. 3.

FIGS. 7A and 7B are perspective views of a bottom housing portion of the cable connector shown in FIG. 3.

FIG. 8 is a perspective view of a separator of the cable connector shown in FIG. 3.

FIGS. 9-15 are perspective views of the cable connector shown in FIG. 3 at various stages of the assembling.

FIG. 16 is a perspective view of the board connector shown in FIG. 1A.

FIG. 17 is an exploded view of the board connector shown in FIG. 16.

FIG. 18 is a perspective view of a portion of an electronic system comprising a cable connector and a board connector, shown as mated with each other, according to some embodiments.

FIG. 19 is a perspective view of the electronic system shown in FIG. 18, with the cable connector and the board connector shown separated from each other.

FIG. 20 is a perspective view of the cable connector shown in FIG. 18.

FIG. 21 is a perspective view of signal and power cable assemblies of the cable connector shown in FIG. 20.

FIG. 22 is a perspective view of the power cable assembly shown in FIG. 21, with a top housing portion hidden.

FIG. 23 is an exploded perspective view of the power cable assembly shown in FIG. 21.

FIG. 24 is a perspective view of a first flexible flat cable (FFC), a second flexible flat cable (FFC), and a separator of the cable connector shown in FIG. 20.

FIG. 25 is an exploded view of an housing of the cable connector shown in FIG. 20.

FIG. 26 is a perspective view of an housing of the cable connector shown in FIG. 20.

FIG. 27 is a cross-sectional view of the housing shown in FIG. 26.

FIG. 28 is an exploded perspective view of the cable connector shown in FIG. 20.

FIGS. 29 and 30 are cross-sectional views of the cable connector shown in FIG. 20.

FIG. 31 is an exploded perspective view of the board connector shown in FIG. 18.

FIG. 32 is a cross-sectional view of the electronic system shown in FIG. 18.

The above accompanying drawings include the following reference signs:
20, board connector; 21, main housing; 20A, second mating end; 20B, second mounting end; 22, second conductive assembly; 23, shielding shell; 23A, board lock; 24, outer housing; 25, holding member; 26, second locking feature; 27, second annular cavity; 30, first circuit board; 31, via;
10, cable connector; 100, first housing; 101, first mating end; 102, first connecting end; 103, mounting channel; 104, 104′, inner conductive layer; 105, 105′, outer conductive layer; 106, first annular cavity; 110, top housing portion; 111, projection; 112, first locking feature; 113, second positioning pin; 120, bottom housing portion; 121, engaging portion; 122, positioning hole; 130, separator; 131, first groove; 133, separator lug; 134, first positioning pin; 140, slot; 150, strengthening rib; 151, first strengthening rib; 152, second strengthening rib; 160, lug groove; 170, positioning slot; 180, recess; 181, first recess; 182, second recess; 200, flexible flat cable; 200A, first flexible flat cable; 200B, second flexible flat cable; 210, substrate; 220, cable conductor; 230, insulating layer; 241, inner surface; 242, outer surface; 250, shielding layer; 251, inner shielding layer; 252, outer shielding layer; 260, cable lug; 270, contact pad; 281, first cable portion; 282, second cable portion; 283, third cable portion; 300, conductive ring; 400, connector position assurance;
920, board connector; 921, housing; 922, conductive terminal; 923, shield; 9231, board lock; 924, outer housing;
910, cable connector; 9100, connector housing; 9101, mating surface; 9102, mounting surface; 9110, mating portion; 9111, supporting portion; 91111, first surface; 91111a, first groove; 91111b, third groove; 91112, second surface; 91112a, second groove; 9120, mounting portion; 9130, mounting hole; 9140, strengthening rib; 9210, connector position assurance; 9220, terminal position assurance; 9221, first arm; 9222, second arm; 9300, housing; 9310, first housing portion; 9311, top wall; 9312, second top wall clamping portion; 93121, top opening; 93122, top beam; 9313, first side wall; 93131, first inner part; 93132, first outer part; 9314, first top wall clamping portion; 9320, second housing portion; 9321, bottom wall; 9322, second bottom wall clamping portion; 93221, bottom opening; 93222, bottom beam; 9323, second side wall; 93231, second inner part; 93232, second outer part; 9324, first bottom wall clamping portion; 9331a, 9331b, inner middle sub-part; 9332a, 9332b, inner end sub-part; 9333a, 9333b, outer middle sub-part; 9334a, 9334b, outer end sub-part; 9340, feature; 9350, opening; 9360, rib; 9400, FFC; 9401, first-type FFC; 9402, second-type FFC; 9410, first notch; 9411, first end; 9412, second end; 9420, contact pad; 9430, substrate; 9440, insulating layer; 9450, first protrusion; 9500, separator; 9510, second notch; 9511, first end; 9512, second end; 9520, second protrusion.

### DETAILED DESCRIPTION

The inventors have recognized and appreciated connector design techniques that enable high-speed, easy maintenance connectors and interconnection systems that may operate reliably in a harsh environment, such as in the environment presented by an automobile. Techniques described herein provide efficient shielding against electromagnetic interference for connectors comprising flexible flat cables. Techniques described herein also enable easy maintenance and replacement of flexible flat cables for the connectors.

According to aspects of the present disclosure, a housing of a cable connector may comprise a body made of an insulating material that can be easily processed into complex structures. For example, insulating materials may include plastics. Optionally, the insulating body may be manufactured by molding. A conductive layer may then be formed on an inner surface and/or an outer surface of the insulating body to shield components within the housing, such that electromagnetic compatibility performance can be improved. This housing may be particularly suitable for harsh environments such as those presented in vehicles. Electromagnetic interference in such settings can severely compromise the signal integrity and stable operation of vehicle electronic systems, potentially leading to unpredictable risks. In some embodiments, the insulating body of the housing may include a mating end, a connecting end, and a mounting channel extending from the connecting end to the mating end. The mounting channel may be defined by an inner surface of the insulating body. The conductive layer may be disposed on the inner surface, the outer surface, or both the inner and outer surfaces of the insulating body. This design allows the insulating body to be processed into the desired complex shape based on design requirements, such as overhanging beams that may cooperate with a connector position assurance.

In some embodiments, the cable connector may further include a flexible flat cable and a conductive member. An end portion of the flexible flat cable may be held within the housing. A shielding layer, such as aluminum foil or copper foil, may be disposed on a surface of the flexible flat cable. This design may shield the conductors, with relatively small impact on the flexibility of the flexible flat cable. The conductive member may be disposed at the mating end of the housing for mating with a complementary electrical connector. The conductive member may protrude from a mating surface of the mating end to interface with a shielding shell of the complementary electrical connector. The conductive member is electrically connected to the conductive layer of the housing. In some embodiments, the conductive layer may include an inner conductive layer disposed on an inner surface of the insulating body and/or an outer conductive layer disposed on an outer surface of the insulating body. When both layers are present, the outer conductive layer may be electrically connected to the inner conductive layer. This configuration enables more effective full shielding once the cable connector is mated with the complementary connector.

In some embodiments, the insulating body may include a top housing portion and a bottom housing portion. The top housing portion may include a first locking feature configured to cooperate with a connector position assurance. The insulating body comprising the top housing portion and the bottom housing portion facilitates mounting the separator and the flexible flat cable therein. Moreover, the insulating body may be split into two parts along a vertical direction, rather than along other directions, such as a horizontal direction. This vertical split may simplify injection molding of the top and bottom housing portions, while accidentally reducing the risk of separating the top and bottom housing portions during daily operations. In some embodiments, one of the top housing portion and the bottom housing portion may include a projection, and the other may include an engaging portion configured to be engaged with the projection.

In some embodiments, the cable connector may include a stacked first flexible flat cable and second flexible flat cable. The first flexible flat cable and the second flexible flat cable may have inner surfaces facing each other and outer surfaces facing outward (opposite the inner surfaces). Optionally, the shielding layer of each flexible flat cable may include an inner shielding layer disposed on the inner surface and/or an outer shielding layer disposed on the outer surface. The inner shielding layer may extend to the proximal end (e.g., front end) of a corresponding flexible flat cable, or even through the entire length of the corresponding flexible flat cable. The outer shielding layer may be spaced apart from the proximal end of the corresponding flexible flat cable to expose the ends of the cable conductors of the corresponding flexible flat cable and form contact pads. Optionally, the outer shielding layer may extend to the distal end (e.g., rear end) of the corresponding flexible flat cable along the length direction. Accordingly, the cable conductors in the flexible flat cables can be encased in the shielding layers as extensively as possible, with the contact pads exposed, thereby improving the electromagnetic compatibility performance. Optionally, the first flexible flat cable and the second flexible flat cable may be structurally identical.

In some embodiments, the cable connector may further include a separator positioned between the end portions of the first flexible flat cable and the second flexible flat cable that are held within the housing. The separator may be clamped by the housing along the stacking direction of the flexible flat cables. When the cable connector mates with a complementary electrical connector (e.g., a board connector), a terminal assembly of the board connector may press against the contact pads supported by the separator, ensuring reliable electrical contact. The density of the cable connector may be improved by use of stacked flexible flat cables. The flexible flat cables can be conveniently and reliably hold in the housing by incorporating a separator between adjacent flexible flat cables. Each flexible flat cable can be fixed via the separator and the housing, simplifying the assembling of the cable connector.

According to aspects of the present disclosure, an electronic system may include a cable connector and a board connector. The cable connector may include a first housing, a first conductive assembly held by the first housing, and a first shielding assembly. The board connector may include a second housing, a second conductive assembly held by the second housing, and a second shielding assembly. When the cable connector mates with the board connector, the first conductive assembly is in electrical contact with the second conductive assembly, and the first shielding assembly and the second shielding assembly form a fully enclosed shielding around the first conductive assembly and the second conductive assembly, to improve electromagnetic compatibility performance.

In some embodiments, an outer conductive layer may be disposed on the outer surface of the first housing. Optionally, a conductive ring may be sleeved over the first housing. The first shielding assembly may include the outer conductive layer and the conductive ring. The second shielding assembly may include a shielding shell held on the second housing. The conductive ring may be electrically bridging the outer conductive layer and the shielding shell when the cable connector mates with the board connector. Accordingly, the outer conductive layer and the shielding shell form a reliable electrical connection to achieve the fully enclosed shielding. Optionally, the conductive ring may be made of an elastic material such as conductive rubber. Optionally, the conductive ring may additionally form a seal between the first housing and the second housing.

In some embodiments, a recess may be disposed in the outer surface of the first housing. The recess may be configured to receive and retain the conductive ring. The conductive ring may protrude slightly beyond the outer surface of the first housing. In this way, when the cable connector is inserted into the board connector, no excessive resistance is generated, and the conductive ring is not damaged by over-compression.

For interconnection systems in vehicles such as new energy vehicles, the growing number of electronic assemblies and increasing data transmission rates have raised high demands for cable transmission rates and/or densities. Enhancing transmission rates and/or densities by increasing the number of cables in electronic assemblies is becoming more challenging, as this approach may complicate assembly and maintenance while hindering the miniaturization of interconnection systems. Flexible Flat Cables (FFCs) may support these enhanced transmission rates while supporting miniaturization. FFCs can transmit data signals and/or supply power, while offering compatibility and flexibility.

According to aspects of the present disclosure, a cable assembly may include FFCs, which may be easily detached from a housing of a connector for complete replacement, or removal of individual FFCs from the cable assembly for individual replacement. In some embodiments, the cable assembly may include a housing, a first FFC, a second FFC, and a separator. The first FFC and the second FFC may be clamped between a top wall and a bottom wall of the housing. The separator may be clamped between the first FFC and the second FFC. The inventors have recognized and appreciated that FFCs are prone to tearing after being twisted or falling off from the housing. Accordingly, the end portions of the FFCs may be clamped by the housing and the separator, such that the end portions are positioned in the length and width directions of the FFCs to prevent the end portions of the FFCs from being misaligned and tearing. The separator may support the first FFC and the second FFC together with a supporting portion in a connector housing, so that the end portions of the first FFC and the second FFC remain flat. The housing may be easily assembled into the connector housing.

In some embodiments, the cable assembly may include a first-type FFC with a relatively low conductor density, which may be used for transmitting low-speed signals and/or power. In some embodiments, the cable assembly may include a second-type FFC with a relatively high conductor density, which may be used for transmitting high-speed and high-density signals.

Optionally, the second-type FFC may include a shielding layer such as copper foil or aluminum foil covering the surface of the insulating layer to improve electromagnetic compatibility (EMC) performance.

In some embodiments, in a cable assembly, the end portions of the first FFC and the second FFC can be accurately positioned relative to the housing. This pre-positioned cable assembly is then inserted into a connector housing to form a complete connector. This approach may simplify the positioning of the connector housing, thereby enhancing the assembly precision and electrical performance of the connector while ensuring excellent batch consistency.

In some embodiments, the top wall and the bottom wall of the housing of the cable assembly may respectively include top wall clamping portions and bottom wall clamping portions. The top wall clamping portions and the bottom wall clamping portions reliably clamp the stacked first FFC, separator and second FFC. In this way, the top wall and the bottom wall can be prevented from contacting the first FFC and the second FFC over a large area, such that the processing accuracy requirements for the housing can be lower. An FFC may include a substrate, a cable conductor formed on the substrate, and an insulating layer covering the cable conductor. The substrate usually has a thickness to provide a certain mechanical strength but has flexibility. In some embodiments, the top wall clamping portions and the bottom wall clamping portions may respectively include first top wall clamping portions and first bottom wall clamping portions that clamp side edges of the first FFC and the second FFC. The first top wall clamping portions and the first bottom wall clamping portions may not contact the insulating layers and the cable conductors of the first FFC and the second FFC. Optionally, the first top wall clamping portions and the first bottom wall clamping portions may be rigid. Optionally, the first top wall clamping portions and the first bottom wall clamping portions may be configured as protrusions. In some embodiments, the top wall clamping portions and the bottom wall clamping portions may respectively include a second top wall clamping portion and a second bottom wall clamping portion that clamp central portions of the first FFC and the second FFC. The second top wall clamping portion and the second bottom wall clamping portion may be pressed against the insulating layers of the first FFC and the second FFC respectively. Optionally, the second top wall clamping portion and the second bottom wall clamping portion may be configured to apply elastic force to the first FFC and the second FFC to avoid damaging the insulating layers and cable conductors of the FFCs. Optionally, the second top wall clamping portion and the second bottom wall clamping portion may be configured as beams. In some embodiments, the top wall clamping portions may include both the first top wall clamping portions and the second top wall clamping portion. The bottom wall clamping portions may include both the first bottom wall clamping portions and the second bottom wall clamping portion.

Optionally, the housing may include a first housing portion and a second housing portion, with the first housing portion including the top wall, and the second housing portion including the bottom wall. Optionally, the first housing portion may include first side walls extending downward from the top wall, and the second housing portion may further include second side walls extending upward from the bottom wall. The first side walls may be connected to the second side walls. Optionally, the first side walls and the second side walls may be connected to each other through snap-fitting.

Optionally, the side edges of the first FFC and the second FFC may include first notches. The separator may include second notches. At least a part of at least one of the first side wall and the second side wall may be engaged with the first notches and/or the second notches, for positioning the first FFC, the second FFC, and the separator along the length direction of the FFCs. Optionally, the first side walls each may include a first inner part and a first outer part, and the second side walls each may include a second inner part and a second outer part. The first inner part and the second inner part may be arranged along the length direction of the FFCs. The first outer part and the second outer part abut against the outer sides of the second inner part and the first inner part respectively. In this way, the first FFC, the second FFC, and the separator may be positioned along the width direction of the FFCs.

Optionally, the first inner parts of the first side walls and the second inner parts of the second side walls may be symmetrical about a first axis parallel to the width direction of the FFCs. The first outer parts of the first side walls and the second outer parts of the second side walls may be symmetrically arranged about the first axis. Optionally, both the first inner parts and the second inner parts may be symmetrically arranged about a second axis parallel to the length direction, respectively. Optionally, both the first outer parts and the second outer parts may be symmetrically arranged about the second axis, respectively. Accordingly, the first housing portion may structurally be identical to the second housing portion, thereby reducing the molds for molding the first housing portion and the second housing portion and lowering processing costs. During assembly, one housing may be rotated by 180 degrees relative to the other housing and then connect the two housings together. Optionally, each of the first outer part and the second outer part may include an outer middle sub-part and an outer end sub-part. A rib may be provided on the outer surface of the outer middle sub-part, and the rib may be spaced apart from an outer end sub-part of a respective outer part to form a gap. The terminal position assurance may hold the cable assembly in the connector housing by engaging with the gap.

Optionally, the connector housing of the cable connector may include a mating portion and a mounting portion opposite to each other along the length direction of the FFCs, as well as a mounting channel extending from the mounting portion into the mating portion. The housing with the FFCs mounted thereon may be inserted into the mounting channel from the mounting portion until the front end of the housing abuts against the mating portion. A supporting portion may be provided in a portion of the mounting channel in the mating portion, and the supporting portion divides the portion of the mounting channel into two sub-channels. The tails of the first FFC and the second FFC with contact pads may be respectively accommodated in the two sub-channels. Then, the housing is held in the connector housing by the terminal position assurance. Optionally, the terminal position assurance may be connected to the connector housing through snap-fitting.

Optionally, a first surface of the separator may include slots opposite to each other along the width direction of the FFCs, and the two side edges of the tail of the first FFC may be respectively inserted into the slots of the first surface to position the tail of the first FFC.

Optionally, a second surface of the separator may include slots opposite to each other along the width direction of the FFCs. The second surface may be opposite to the first surface along the stacking direction of the FFCs. The two side edges of the tail of the second FFC may be respectively inserted into the slots of the second surface to position the tail of the second FFC.

Optionally, the cable connector may be mated with a complementary connector such as a board connector. The board connector may include a housing, a plurality of conductive terminals, a cage, and an outer housing. The plurality of conductive terminals may be held in the housing. The cage may surround the housing along the circumferential direction of the conductive terminals. The outer housing may surround the cage along the circumferential direction.

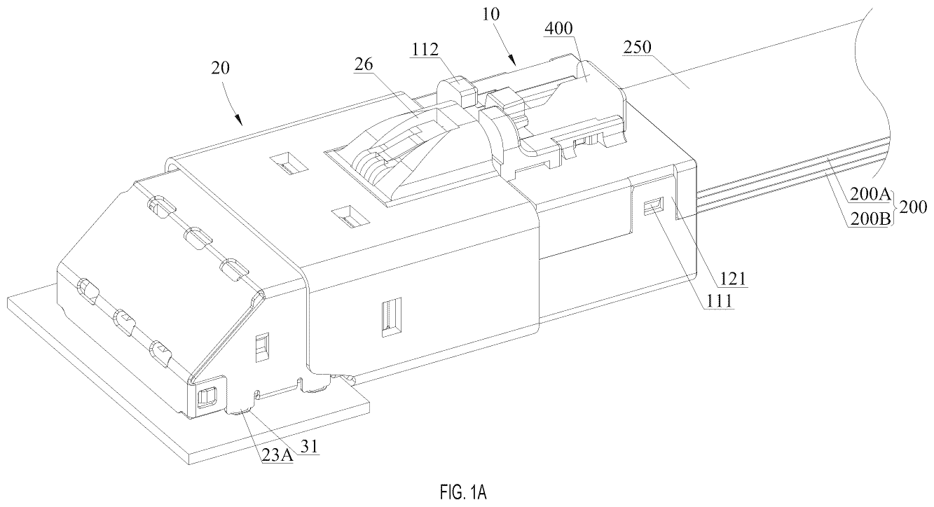

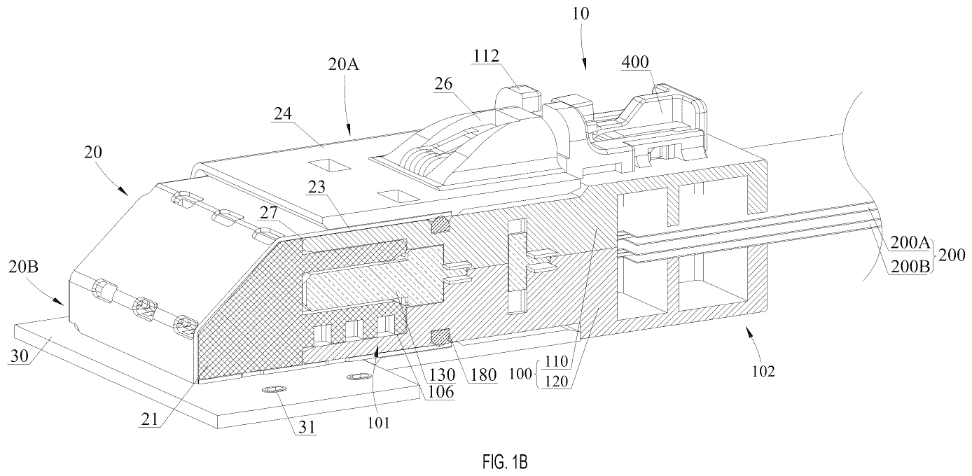

FIGS. 1A to 1B show a part of an electronic system, such as that used in an automobile, for interconnecting a plurality of electronic devices in the electronic system. As shown, the electronic system may include a cable connector 10 and a board connector 20 that is detachably mated with the cable connector 10. The cable connector 10 may include a first housing 100, a first conductive assembly held by the first housing 100, and a first shielding assembly. The board connector 20 may include a second housing, a second conductive assembly held by the second housing, and a second shielding assembly. The board connector 20 may be mounted to a circuit board, e.g., a first circuit board 30. The cable connector 10 may include flexible flat cables 200. The cable connector 10 may be electrically connected to an electronic device, such as another circuit board (e.g., a second circuit board) via the flexible flat cables 200, allowing the second circuit board to be positioned remotely from the first circuit board 30. Optionally, the first conductive assembly may include the flexible flat cables 200. The second conductive assembly is electrically connected to the second circuit board. When the cable connector mates with the board connector, the first conductive assembly and the second conductive assembly are in electrical contact, so that the cable connector 10 and the board connector 20 may provide interconnection between the first circuit board 30 and the second circuit board. In some embodiments, the first circuit board 30 onto which the board connector 20 is mounted may be fixed within another electronic device. In harsh environments such as those presented by automobiles, electronic systems can enable data signal transmission. When the cable connector mates with the board connector, the first shielding assembly and the second shielding assembly form a fully shielded electromagnetic interference (EMI) room at the periphery of the first conductive assembly and the second conductive assembly. The fully shielded room can effectively improve electromagnetic compatibility performance.

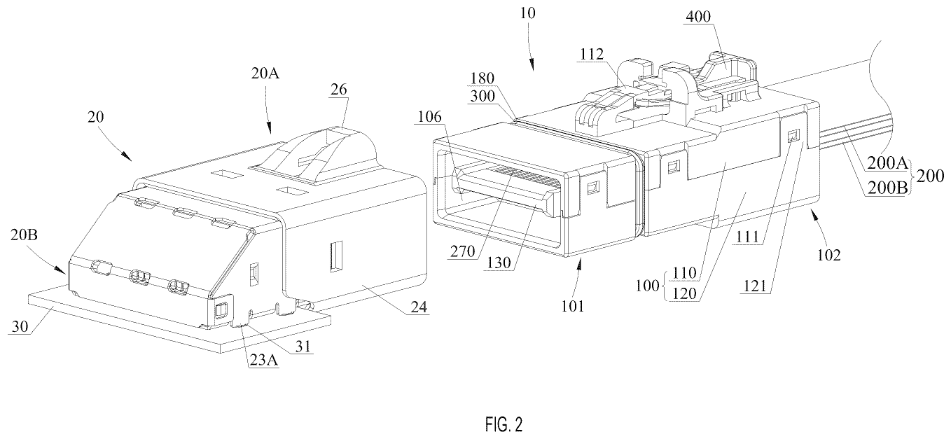

With reference to FIGS. 2 to 5, the cable connector 10 may include a first housing 100 and a first conductive assembly held by the first housing 100. The first housing 100 may include an insulating body. The insulating body may be made of non-metallic materials, including but not limited to plastics and ceramics. In some embodiments, the insulating body may be molded from a material such as plastic. Plastic may include, but is not limited to, liquid crystal polymer (LCP), polyphenylene sulfide (PPS), high-temperature nylon, poly-p-phenylene oxide (PPO), or polypropylene (PP), or any other suitable material. In some cases, the plastic may be a thermosetting plastic. In some cases, the insulating plastic may include an insulating material such as fiberglass reinforcement. The plastic is lightweight and deformable under external force. This allows the insulating body to be assembled together by to reduce costs.

A connector position assurance 400 may be mounted to the first housing 100. Optionally, the first housing 100 may include a first locking feature 112. The connector position assurance 400 may be mounted to the first housing 100 by the first locking feature 112. For the convenience of observation and operation in use, the cable connector 10 may be usually mated with the board connector 20 with the first locking feature 112 facing upward. Accordingly, the side of the first housing 100 with the first locking feature 112 may be referred to as the top side. Optionally, the board connector 20 may include a second locking feature 26. After the cable connector 10 is mated with the board connector 20, the first locking feature 112 can be locked to the second locking feature 26 by operating the connector position assurance 400 to prevent accidental separation of the two connectors. One of the first locking feature 112 and the second locking feature 26 may be configured to include a protrusion, and the other may be configured to include a recess or groove capable of engaging with the protrusion.

The insulating body of the first housing 100 may include a first mating end 101 which may be mated with the board connector 20. The insulating body may further include a first connecting end 102. The first connecting end 102 and the first mating end 101 may be located at two ends of the insulating body. The first conductive assembly may include the flexible flat cables 200. End portions of the flexible flat cables 200 are held within the first housing 100. In some embodiments, the end portions of the flexible flat cables 200 may extend to the first mating end 101 of the insulating body from the first connecting end 102. In the illustrated embodiment, the axes of the first mating end 101 and the first connecting end 102 are substantially parallel, so that the end portions of the flexible flat cables 200 within the insulating body is substantially straight. In an unillustrated embodiment, the axis of the first mating end 101 may be perpendicular to that of the first connecting end 102, in which case the end portions of the flexible flat cables 200 within the insulating body may be bent. Optionally, the insulating body may include a mounting channel 103 extending from the first connecting end 102 to the first mating end 101, and the end portions of the flexible flat cables 200 may be mounted in the mounting channel 103. In some embodiments, the insulating body may be integrally molded with the mounting channel 103. In other embodiments, the mounting channel 103 may be formed in a solid insulating body via a suitable process, such as machining. For embodiments where the insulating body comprises at least two parts, the mounting channel 103 may optionally be provided in one of the parts, or be defined by the inner surfaces of the two parts together.

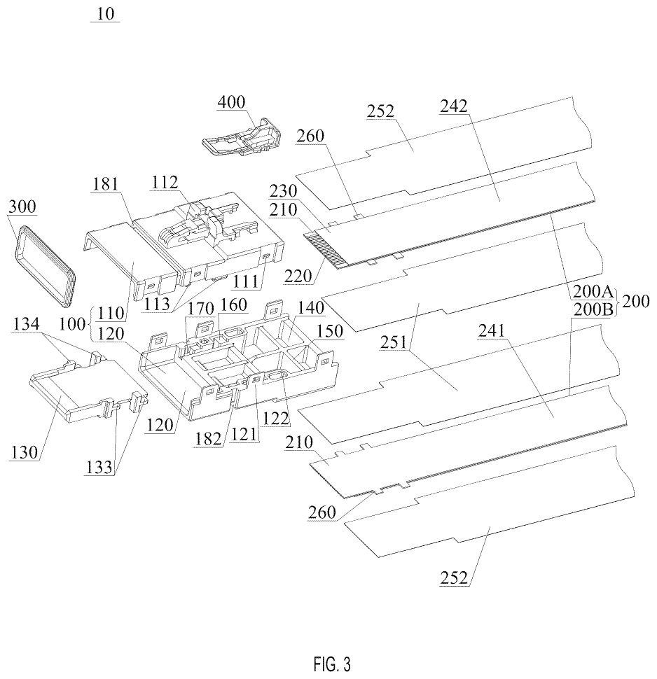

Referring to FIG. 3, the flexible flat cables 200 each may include a substrate 210, cable conductors 220 formed on the substrate 210, and an insulating layer 230 covering the cable conductors 220. The substrate 210 is typically insulating, with greater thickness and mechanical strength than the insulating layer 230, while still maintaining flexibility. The cable conductors 220 may be formed on the substrate 210 via a suitable process, such as adhesion, hot-melting.

The insulating layer 230 may expose portions of the cable conductors 220 on the end portion of the flexible flat cable 200 to form contact pads 270. The contact pads 270 may be located within the first mating end 101. In other embodiments, the first conductive assembly may further include a printed circuit board located within the first mating end 101. The printed circuit board may include contact pads 270. The contact pads 270 may be electrically connected to the cable conductors 220 of the flexible flat cables 200 or cores of common cables by a suitable method, such as soldering, crimping, or conductive tape bonding.

The board connector 20 may include a second housing and a second conductive assembly 22 held by the second housing. The second housing may include a second mating end 20A and a second mounting end 20B at two ends. The second mating end 20A is configured to be mated with the first mating end 101. Optionally, the second mating end 20A and the first mating end 101 may be complementary in shape such that the cable connector 10 can be accurately positioned onto the board connector 20. The second conductive assembly 22 may extend from the second mating end 20A to the second mounting end 20B. The second conductive assembly 22 may include a plurality of conductive terminals for electrical connection with the contact pads 270 respectively after the cable connector 10 is mated with the board connector 20. As shown, the second mounting end 20B may be mounted to the first circuit board 30, so that the plurality of conductive terminals of the second conductive assembly 22 form electrical connections with circuits in the first circuit board 30, thereby interconnecting the first circuit board 30 with the cable connector 10. To reliably fasten the board connector 20 to the first circuit board 30, the board connector 20 may further include a board lock 23A. Optionally, the first circuit board 30 may comprise a via 31, and the board lock 23A may be inserted into the via 31 to fix the board connector 20 to the first circuit board 30. In some embodiments, the second housing may also be molded from a material such as plastic. Plastic may include, but is not limited to, liquid crystal polymer (LCP), polyphenylene sulfide (PPS), high-temperature nylon, poly-p-phenylene oxide (PPO), or polypropylene (PP), or any other suitable material. In some cases, the plastic may be a thermosetting plastic. In some cases, the insulating plastic may include an insulating material such as fiberglass reinforcement. The plastic material is lightweight, has deformability under external force, easy to process, and low in cost.

Optionally, the surfaces of the contact pads 270 of the first conductive assembly and/or the surfaces of the second conductive assembly 22 each may be formed with a noble metal layer to avoid poor contact caused by oxidation.

As shown in FIGS. 3, 4A-4B, and 5, a flexible flat cable 200 may optionally be used to increase the density of the contact pads 270 of the cable connector 10. To further increase the density, the cable connector 10 may include a plurality of stacked flexible flat cables 200. The end portions of the plurality of flexible flat cables 200 extend from the first connecting end 102 to the first mating end 101 via, for example, the mounting channel 103 and are held in the mounting channel 103. In the illustrated embodiment, the flexible flat cables 200 each may be configured to have contact pads 270. The contact pads 270 may be located within the first mating end 101. Optionally, the plurality of flexible flat cables 200 are arranged in one or more pairs, and each pair of flexible flat cables 200 are stacked along the thickness direction of the flexible flat cables 200. The contact pads 270 of each pair of flexible flat cables 200 may be oriented in opposite directions for electrical contact with terminals of a complementary electrical connector. In the illustrated embodiment, the cable connector 10 may include a pair of flexible flat cables 200. In other unillustrated embodiments, the cable connector 10 may include a plurality of pairs of flexible flat cables 200, and the pairs may be arranged in a row along the width direction of the flexible flat cables 200. Optionally, more than two flexible flat cables 200 may be arranged along the stacking direction of the flexible flat cables 200. In this case, the flexible flat cables 200 with contact pads 270 oriented in the same direction may be staggered along their length direction to expose the contact pads 270 of the underlying flexible flat cable(s) 200.

Optionally, the cable connector 10 may further include one or more separators 130.

Every two adjacent flexible flat cables 200 are separated by a separator 130. Optionally, the one or more separators 130 are clamped by the first housing 100 along the stacking direction of the plurality of flexible flat cables 200. In some embodiments, each separator 130 may correspond to two flexible flat cables 200. For convenience of description, two flexible flat cables 200 are defined as a first flexible flat cable 200A and a second flexible flat cable 200B. In some embodiments, the two opposite surfaces of the separator 130 may be attached to back surfaces of the first flexible flat cable 200A and the second flexible flat cable 200B, respectively. In the illustrated embodiment, the portions of the first flexible flat cable 200A and the second flexible flat cable 200B with the contact pads 270 may be fully attached to the separator 130 such that the contact pads 270 abut against flat surfaces. When the cable connector 10 mates with the board connector 20, the terminals of the board connector 20 may press against the contact pads 270 for reliable electrical contact. Optionally, along the length direction of the flexible flat cables 200, the separator 130 may be longer than the contact pads 270, allowing more of the flexible flat cables 200 to be supported by the separator 130. The separator 130 may cooperate with the first housing 100 to hold the first flexible flat cable 200A and the second flexible flat cable 200B on two sides thereof, with the first flexible flat cable 200A clamped between the separator 130 and a top housing portion 110 of the first housing 100, and the second flexible flat cable 200B clamped between the separator 130 and a bottom housing portion 120 of the first housing 100.

Optionally, the first housing 100 may be an integral member, and the separator 130 may be inserted into the mounting channel 103 from the first connecting end 102. Optionally, the first housing 100 may comprise multiple separate components, for example, a top housing portion 110 and a bottom housing portion 120. The separator 130 may be mounted to the bottom housing portion 120, and then the top housing portion 110 is assembled to the bottom housing portion 120, so that the separator 130 is held in the mounting channel 103.

Optionally, the present application may also include embodiments where a single flexible flat cable 200 is arranged along the stacking direction.

Optionally, the one or more separators 130 may be installed in the mounting channel 103 to separate at least two stacked flexible flat cables 200 and position the end portions of the flexible flat cables 200. Accordingly, each separator 130 may be shaped as a flat sheet, as shown. In some embodiments, each separator 130 may be inserted into the mounting channel 103 from the first connecting end 102, and secured in place via suitable structures, such as features or screws. Referring back to FIGS. 2 and 3, in the illustrated embodiment, the first housing 100 may include multiple separated members. The separator 130 and the flexible flat cables 200 may be mounted to one of the members, e.g., a first member, and then the other member, e.g., a second member, is assembled with the first member, thereby positioning the separator 130 and/or the flexible flat cables 200, with the flexible flat cables 200 extending beyond the first housing 100 from a rear opening of the mounting channel 103. The separator 130 has two opposite flat surfaces, each supporting a proximal end of the end portion of a flexible flat cable 200 as shown. In an unillustrated embodiment, the width of the flat surfaces may be larger than that of the proximal ends of the flexible flat cables 200, so that each flat surface can support proximal ends of multiple flexible flat cables 200 side by side.

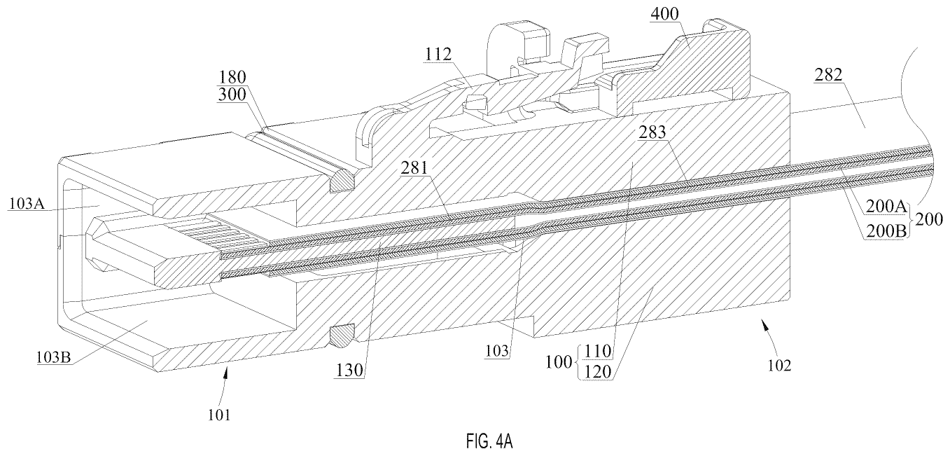

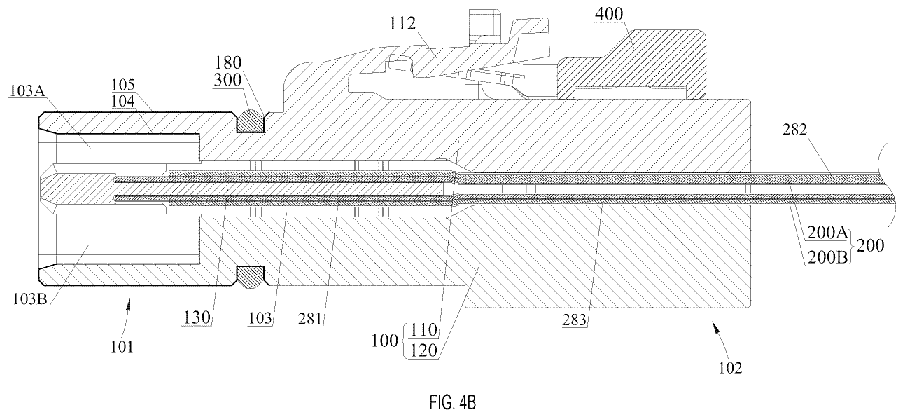

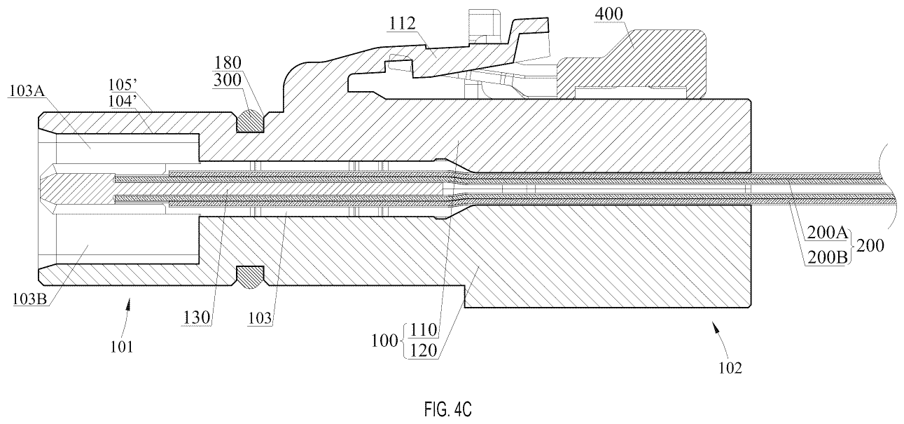

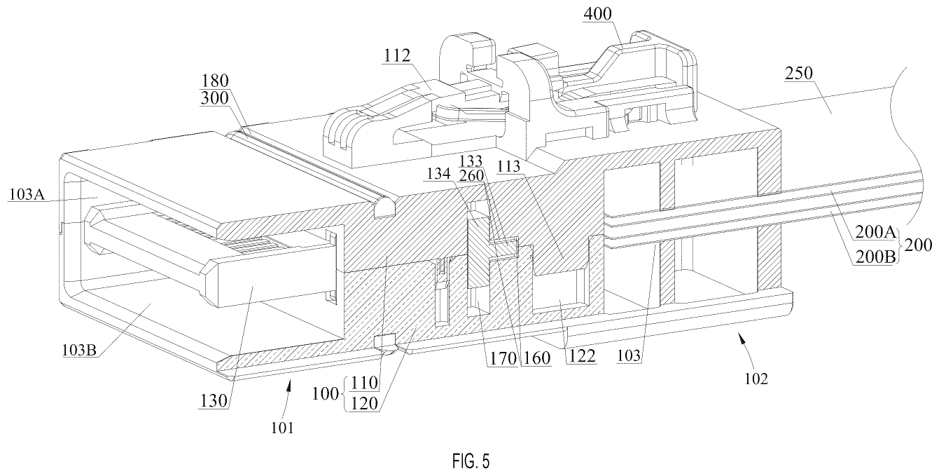

Optionally, the separator 130 may divide at least the front portion of the mounting channel 103 into a first mounting sub-channel 103A and a second mounting sub-channel 103B. Both the first mounting sub-channel 103A and the second mounting sub-channel 103B may extend from the first mating end 101 toward the first connecting end 102, spaced apart from the first connecting end 102. As shown in FIGS. 4A-4B and 5, the separator 130 is located in the middle of the mounting channel 103 in the stacking direction of the flexible flat cables 200 to separate the first mounting sub-channel 103A and the second mounting sub-channel 103B on its upper and lower sides, respectively. The end portions of the first flexible flat cable 200A and the second flexible flat cable 200B may be inserted into the first mounting sub-channel 103A and the second mounting sub-channel 103B, respectively. In the first mating end 101, the separator 130 is also spaced apart from the first housing 100 along the width direction of the flexible flat cables 200 to form a first annular cavity 106 between the separator 130 and the first housing 100. This allows an inner layer of the second mating end 20A of the board connector 20 to be inserted into the first annular cavity 106 to increase the mechanical connection strength. As described hereinafter, the second mating end 20A of the board connector 20 also has an outer layer surrounding the outer side of the first mating end 101 of the first housing 100 to further enhance the mechanical connection strength. The separator 130 is positioned in the first mating end 101 of the first housing 100 to match the complementary connector.

In some embodiments, the end of the first conductive assembly may be mounted to the separator 130. The first annular cavity 106 may be formed between the separator 130 and the first housing 100. The first annular cavity 106 may surround the end of the first conductive assembly. The second housing may include a main housing 21. The second conductive assembly may be held in a main housing 21. A front portion of the main housing 21 may be inserted into the first annular cavity 106. The second conductive assembly may be electrically connected to the end of the first conductive assembly.

In the embodiment shown in FIG. 3, the insulating body of the first housing 100 may include a top housing portion 110 and a bottom housing portion 120. By manufacturing the first housing 100 through separate processing, such as injection molding, slots 140 can be formed inside the top housing portion 110 and bottom housing portion 120. Strengthening ribs 150 may be disposed in the slots 140 to enhance the mechanical strength of the top housing portion 110 and the bottom housing portion 120. This separate processing approach reduces the material consumption of the top housing portion 110 and bottom housing portion 120 while lightening their weight. Additionally, it can also facilitate the installation of the separator 130 and the flexible flat cables 200 in the mounting channel 103. In use, a user usually pinches the top housing portion 110 and the bottom housing portion 120 with his fingers and inserts the cable connector 10 into the board connector 20. Accordingly, splitting the first housing 100 into the top housing portion 110 and the bottom housing portion 120 can facilitate injection molding of the first housing 100, while reducing the risk of accidentally separating the top housing portion 110 and the bottom housing portion 120 in use. Additionally, the top housing portion 110 may include a first locking feature 112 configured to cooperate with the connector position assurance 400 to lock with the board connector 20.

Optionally, the connector position assurance 400 may be movable forward or backward in the length direction of the flexible flat cables 200. The term “forward” used herein refers to a direction parallel to the length of the flexible flat cables 200 and toward the complementary electrical connector, while the term “backward” refers to a direction opposed to “forward”, e.g., away from the complementary electrical connector. If there is a need to lock the interconnected cable connector 10 and board connector 20, the connector position assurance 400 may be inserted into a gap between the first locking feature 112 and the top housing portion 110 by pushing it forward. Optionally, the first locking feature 112 may have a locking protrusion configured to engage with a locking opening of the board connector 20, thereby achieving the locking of the cable connector 10 to the board connector 20. When unlocking of the cable connector 10 from the board connector 20 is required, the connector position assurance 400 may be moved backward. This causes the connector position assurance 400 to exit the gap between the first locking feature 112 and the top housing portion 110, allowing the first locking feature 112 to move toward the top housing portion 110 under external force. In this way, the locking protrusion of the first locking feature 112 can be disengaged from the locking opening of the board connector 20, enabling the cable connector 10 and the board connector 20 to be separated from each other under external force. It should be appreciated that any other suitable connector position assurance may be used.

Optionally, one of the top housing portion 110 and the bottom housing portion 120 may include a projection, and the other of the top housing portion 110 and the bottom housing portion 120 may include an engaging portion 121. In the illustrated embodiment, the top housing portion 110 comprises an outward projection 111, and the bottom housing portion 120 comprises an engaging portion 121 extending toward the top housing portion 110. Optionally, the engaging portion 121 may be elastically deformable and include an opening. When the top housing portion 110 is connected to the bottom housing portion 120, the engaging portion 121 may deform outward under the guidance of an inclined surface of the projection 111, so that the projection 111 fits into and engages with the opening. This design facilitates injection molding of the top housing portion 110 and the bottom housing portion 120. In other embodiments not shown, the bottom housing portion 120 may include a projection, and the top housing portion 110 may include an engaging portion. The projection and the engaging portion enable the top housing portion 110 to be detachably connected to the bottom housing portion 120 at low costs.

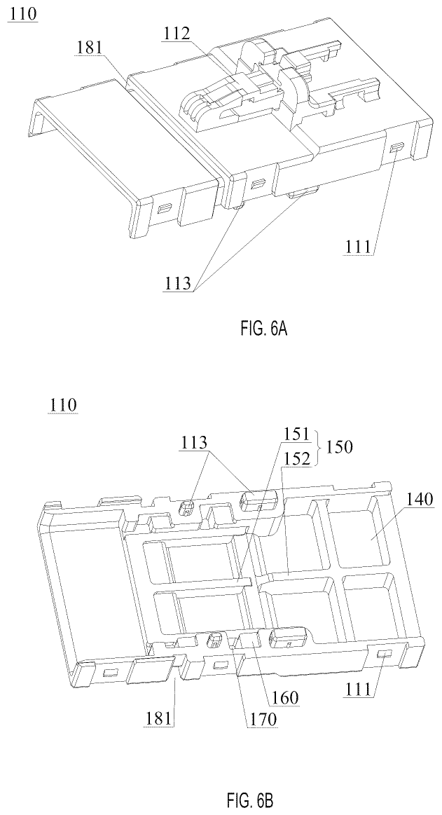

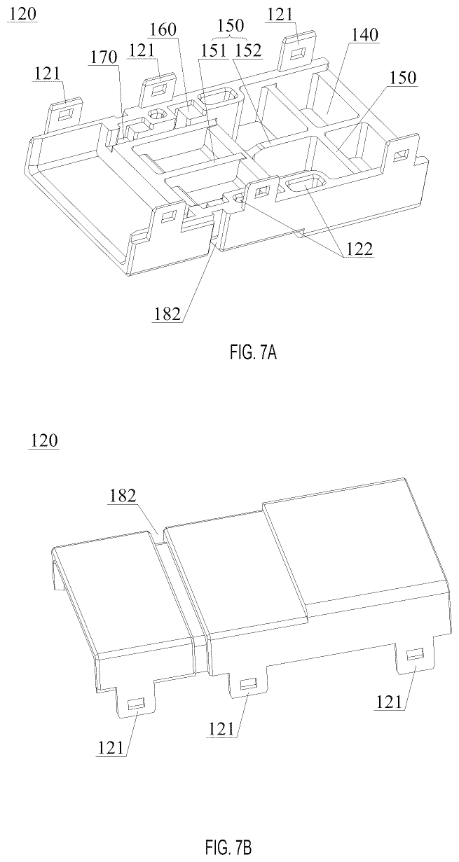

With reference to FIGS. 6A-6B and 7A-7B, the top housing portion 110 may comprise a second positioning pin 113 inserted into a positioning hole 122 of the bottom housing portion 120, such that the top housing portion 110 can be aligned with the bottom housing portion 120. In other embodiments not shown, the second positioning pin may be disposed on the bottom housing portion, with the positioning hole on the top housing portion. Alternatively, the top housing portion and the bottom housing portion each may be provided with a second positioning pin, and accordingly each may be provided with a positioning hole (e.g., the pin of the top housing portion mates with the hole of the bottom housing portion, and vice versa). As shown in FIG. 5, the second positioning pin 113 is inserted into the positioning hole 122.

Optionally, the first housing 100 may further include a positioning slot 170, and the separator 130 includes a first positioning pin 134 inserted into the positioning slot 170 to position the separator 130 within the first housing 100. In some embodiments, the first positioning pin 134 may form a tight fit with the positioning slot 170. In this way, once the first positioning pin 134 is inserted into the positioning slot 170, the separator 130 can be positioned along both the length and width directions of the flexible flat cables 200. Optionally, the separator 130 may include separator lugs 133 on side edges thereof, as shown in FIGS. 3, 5 and 8-11. The top housing portion 110 and the bottom housing portion 120 can also clamp the separator lugs 133 from above and below, respectively, so that the separator 130 can be limited along the stacking direction of the flexible flat cables 200.

Optionally, the end portion of each flexible flat cable 200 may include cable lugs 260 on side edges thereof. The cable lugs 260 may be positioned to correspond with the separator lugs 133. The cable lugs 260 may be formed on portions of the flexible flat cables 200 that are free of the cable conductors 220. The cable lugs 260 and the separator lugs 133 may be engaged with the first housing 100 together to limit the positions of the flexible flat cables 200 and the separator 130 along the length direction of the flexible flat cables 200. The top housing portion 110 and the bottom housing portion 120 can also position the flexible flat cables 200 and the separator 130 along the length direction by clamping the cable lugs 260 toward the separator lugs 133, respectively. As shown in FIGS. 5 and 6A, both the top housing portion 110 and the bottom housing portion 120 of the first housing 100 may include lug grooves 160. The cable lugs 260 and the separator lugs 133 may be engaged with the lug grooves 160, In some embodiments, embedded in the lug grooves 160. After the top housing portion 110 is assembled with the bottom housing portion 120, the flexible flat cables 200 and the separator 130 can be positioned in the stacking direction of the flexible flat cables 200. In some embodiments, the top housing portion 110 and the bottom housing portion 120 may directly press against the flexible flat cables 200, which in turn clamp the separator 130 between the flexible flat cables 200. For example, the conductive housing may press against the cable lugs 260 along the stacking direction.

Alternatively or additionally, the top housing portion 110 and the bottom housing portion 120 press against the separator 130, which then works with the two housings to the flexible flat cables 200 along the stacking direction. The edges of the cable lugs 260 and the separator lugs 133 abut against the lug grooves 160 in the length direction. The first housing 100 may form a tight fit with both sides of the flexible flat cables 200 in the width direction, when the flexible flat cables 200 are installed to the first housing 100. In the embodiment shown in the figures, the flexible flat cables 200 and the separator 130 are positioned through engagement of the cable lugs 260 and the separator lugs 133 with the first housing 100 in the length direction, rather than through direct clamping by the first housing 100 in the stacking direction. This allows the top housing portion 110 and the bottom housing portion 120 to exert relatively low clamping force, reducing requirements for material strength and assembly precision while lowering costs.

In some embodiments, the flexible flat cables 200 each may include a plurality of cable lugs 260 arranged along the length direction of the flexible flat cables 200. The separator 130 may similarly include a plurality of separator lugs 133 arranged along the length direction of the flexible flat cables 200. After the flexible flat cables 200 and the separator 130 are installed into the first housing 100, Optionally, the projections of the cable lugs 260 onto the separator 130 along the stacking direction may all fall within the separator lugs 133. This configuration allows the separator lugs 133 to support the cable lugs 260, reducing the likelihood of the latter breaking.

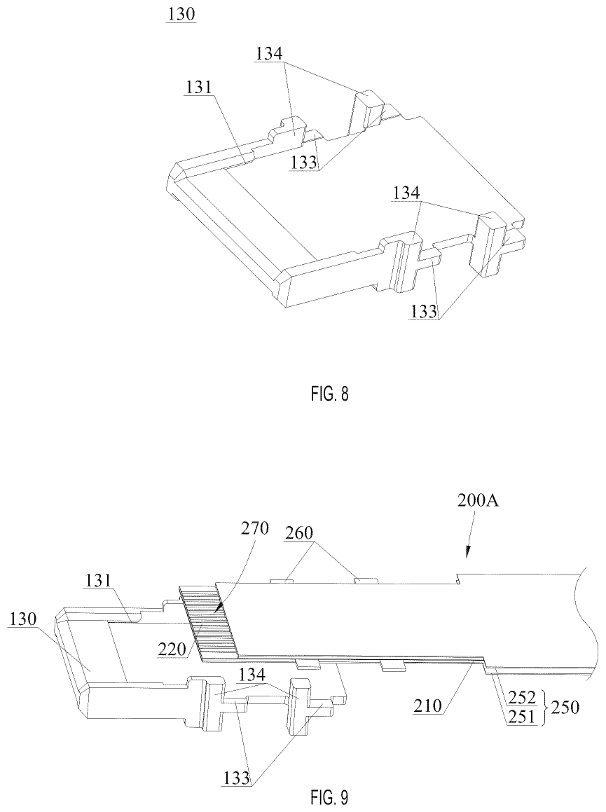

The flexible flat cables 200 may warp in use, due to aging, vibration, or stress. This warping may damage the flexible flat cables 200 or the conductive terminals of the board connector 20 when the cable connector 10 is mated with the board connector 20. Optionally, for each of the flexible flat cables 200, the separator 130 may include a first groove 131 as shown in FIGS. 8 to 9 and a second groove structurally symmetric to the first groove 131 about an axis of the corresponding flexible flat cable 200 parallel to its length direction. The first groove 131 and the second groove extend along the length direction and be opposite along the width direction of the corresponding flexible flat cable 200. The two side edges of the flexible flat cable 200 are respectively inserted into the first groove 131 and the second groove. With reference to FIGS. 8, 9 and 11, the top surface and the bottom surface of the separator 130 each may be provided with a first groove 131 and a second groove. Accordingly, for each flexible flat cable 200, the first groove 131 and the second groove may press the flexible flat cable 200 against the surface of the separator 130 at the two side edges thereof, thereby preventing the flexible flat cable 200 from warping and prolonging the service life.

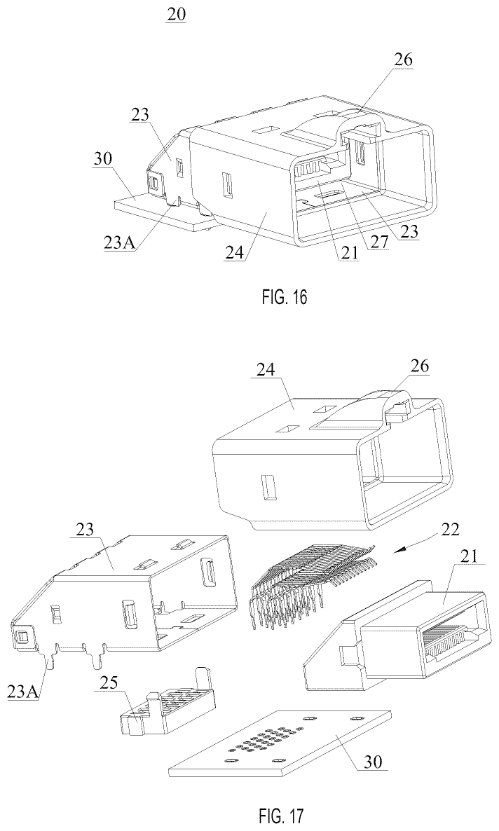

To improve the signal integrity of the electronic system including the cable connector 10 and the board connector 20, optionally, the cable connector 10 may include a first shielding assembly, while the board connector 20 may include a second shielding assembly. The first shielding assembly may include a conductive layer. The second shielding assembly may include a shielding shell 23. As shown in FIGS. 16-17, the shielding shell 23 may semi-enclose or fully enclose the second conductive assembly 22 along the circumferential direction of the second conductive assembly 22 of the board connector 20. The first shielding assembly and the second shielding assembly form a shielding when the cable connector 10 mates with the board connector 20. In some embodiments, the first shielding assembly and the second shielding assembly may substantially surround the contact portions of both the first conductive assembly of the cable connector 10 and the second conductive assembly 22 along the circumferential direction. In other embodiments, the first shielding assembly and the second shielding assembly may substantially surround a portion of the second conductive assembly 22 in the board connector 20 and a portion of the first conductive assembly in the first housing 100 of the cable connector 10 along the circumferential direction. Optionally, the first shielding assembly and/or the second shielding assembly may be electrically connected to a reference potential (e.g., ground).

Optionally, the first shielding assembly may be in electrical contact with the second shielding assembly after the cable connector 10 mates with the board connector 20. In this case, the first shielding assembly and the second shielding assembly may alternatively be electrically connected to the reference potential. Optionally, the board connector 20 is mounted to the first circuit board 30, and the second shielding assembly may be electrically connected to a reference potential of the first circuit board 30.

As shown in FIG. 4B, the first housing 100 may further include a conductive layer disposed on a surface of the insulating body, such as an inner conductive layer 104 and/or an outer conductive layer 105. The first shielding assembly may include the conductive layer.

Optionally, the inner conductive layer 104 may partially cover the inner surface of the insulating body, e.g., the inner wall of the mounting channel 103. Optionally, the inner conductive layer 104 may substantially surround at least portions of the flexible flat cables 200 along the circumferential direction of the flexible flat cables 200. This configuration provides effective electromagnetic shielding and enhances the electromagnetic compatibility performance of the electrical connector. Optionally, the inner conductive layer 104 may be located at the first mating end 101. The inner conductive layer 104 may extend rearward from a front surface of the first mating end 101 facing the complementary electrical connector, for example, at least beyond the contact pads 270. Optionally, the inner conductive layer 104 may extend rearward from the front surface of the first mating end 101 by 20%, 25%, 30%, 35%, 40%, 45%, 50%, 55%, 60%, 65%, 70%, 75%, 80%, 85%, 90%, 95%, or 100% of the total length of the insulating body, or any value therebetween. FIG. 4C shows an embodiment in which the inner conductive layer 104′ extends the entire length of the insulating body. Optionally, the outer conductive layer 105 may partially cover the outer surface of the insulating body. Optionally, the outer conductive layer 105 may substantially surround at least portions of the flexible flat cables 200 along the circumferential direction of the flexible flat cables 200. This configuration provides effective electromagnetic shielding and enhances the electromagnetic compatibility performance of the electrical connector. Optionally, the outer conductive layer 105 may be located at the first mating end 101. The outer conductive layer 105 may extend rearward from the front surface of the first mating end 101 facing the complementary electrical connector, for example, at least to a conductive ring 300. The conductive ring 300 can be electrically connected to the shielding assembly of the board connector 20 when the cable connector 10 mates with the board connector 20. Optionally, the outer conductive layer 105 may extend rearward from the front surface of the first mating end 101 by 20%, 25%, 30%, 35%, 40%, 45%, 50%, 55%, 60%, 65%, 70%, 75%, 80%, 85%, 90%, 95%, or 100% of the total length of the insulating body, or any value therebetween. FIG. 4C shows an embodiment in which the outer conductive layer 105′ extends the entire length of the insulating body. Optionally, in the case where the outer conductive layer 105′ covers the outer surface of the insulating body over the entire length, an inner conductive layer 104 may cover a part of the inner surface of the insulating body. Optionally, in the case where the outer conductive layer 105 covers a part of the outer surface of the insulating body along the length direction, an inner conductive layer 104′ may cover the entire inner surface of the insulating body.

In some embodiments, the conductive layer may comprise conductive paint coated onto the insulating body. In other embodiments, the conductive layer may include a plating layer formed on the insulating body by, for example, electrochemical plating. The plating layer can cover nearly all areas of the insulating body, featuring a uniform thickness and smooth surface.

In the embodiment shown in the figures, the first housing 100 may comprise multiple separate components. The conductive layers on these separate components of the first housing 100 can be in electrical contact with each other, thereby forming a shield that surrounds the mounting channel 103. In other embodiments, the first housing 100 may be an integrally formed member. The first mating end 101 may have a shape complementary to that of the second mating end 20A of the board connector 20. This complementary design enhances the mechanical connection strength between the first housing 100 and the board connector 20 as well as the reliability of electrical connection between the conductive layer on the first housing 100 and the shielding shell 23 of the board connector 20, when the first mating end 101 mates with the second mating end 20A of the board connector 20.

In the embodiments where the conductive layer includes an outer conductive layer 105 or 105′ and an inner conductive layer 104 or 104′, the shielding layer is electrically connected to the inner conductive layer 104 or 104′, and the inner conductive layer 104 or 104′ is electrically connected to the outer conductive layer 105 or 105′. In this way, the conductive layers on the insulating body can be electrically connected to the shielding layer, further expanding the shielding protection range. In some embodiments, the conductive layer may continuously cover a portion or all of the surfaces of the insulating body. In some embodiments, the conductive layer may continuously cover at least a portion of the surfaces of insulating body. In some embodiments, the conductive layer may discontinuously cover at least a portion of the surfaces of insulating body. For example, the conductive layer may be arranged in a grid pattern on the surfaces of insulating body.

In an exemplary embodiment, the conductive layer may entirely cover the inner surface and/or the outer surface of insulating body. This can provide enhanced shielding performance.

Optionally, the conductive layer may be formed by any suitable method, such as spraying, electroplating, electrochemical plating. During long-term use, the part of the conductive layer inserted into the board connector 20 may peel off partially due to friction. If the conductive layer covers the entire inner surface or the entire outer surface of insulating body, the remaining conductive layer can still provide the desired shielding performance.

In a preferred embodiment, the conductive layer may completely cover the surfaces of insulating body, completely enclosing insulating body such that no portion of insulating body is exposed. When the conductive layer adheres properly to insulating body, the inherent tensile stress within the conductive layer may further prevent it from peeling away from insulating body. Additionally, electrochemical plating is preferred for forming the conductive layer on the insulating body, as it offers distinct advantages, enabling control of layer thickness and ensuring excellent layer uniformity. The electrochemical plating also facilitates the formation of a continuous, intact conductive layer across all the surfaces of the insulating body.

The fully enclosed conductive layer also ensures a reliable electrical connection between the outer conductive layer 105 on the outer surface of the insulating body and the inner conductive layer 104 on the inner surface of the insulating body. In some embodiments, each flexible flat cable 200 is covered with a shielding layer 250, which can establish an electrical connection with the shielding shell 23 of the board connector 20 through the fully enclosed conductive layer. The conductive layer and the shielding shell 23 together can thus form a fully enclosed shielding around the conductors in the cable connector 10 and the board connector 20. Additionally, the shielding layer 250 may substantially cover the flexible flat cable 200 along the length and width directions of the flexible flat cable 200, except for the exposed contact pads 270. However, since the contact pads 270 are situated within the insulating housing covered by the conductive layer, the contact pads 270 remain well shielded. Accordingly, the shielding layer 250, combined with the conductive layer and the shielding shell 23, can form a fully enclosed shielding for all conductors in the cable connector 10 and the board connector 20. The fully enclosed conductive layer can prevent foreign substances, such as water vapor, organic vapor, etc., from infiltrating the interface between the conductive layer and the insulating body. This ensures sufficient adhesion between the conductive layer and the insulating body, minimizing the risk of peeling. In some embodiments, the conductive layer may further be configured to protect the insulating body, improving its wear resistance, high temperature resistance, and corrosion resistance.

In some embodiments, the first shielding assembly may further comprise a conductive member disposed at the first mating end 101 of the first housing 100 that mates with a complementary electrical connector. The conductive member protrudes from a mating surface of the first mating end 101 that interfaces with a shielding shell 23 of the complementary electrical connector. The conductive member may be electrically connected to the conductive layer on the insulating body. In some embodiments, the mating surface is on the inner side of the first mating end 101, and the conductive member may be disposed on the inner side of the first mating end 101. In other embodiments, the mating surface is on the outer side of the first mating end 101, and the conductive member may be disposed on the outer side of the cable connector. As mentioned above, the conductive layer may include an inner conductive layer 104 or 104′ disposed on the inner surface of the first housing 100 and/or an outer conductive layer 105 or 105′ disposed on the outer surface of the first housing 100. In the embodiments where the conductive member is disposed outside the first housing 100 and the first housing 100 comprises an inner conductive layer 104 or 104′ on the inner surface of the insulating body, the conductive member may be connected to the inner conductive layer 104 or 104′ through, for example, a through hole on the first housing 100. In the embodiments where the first housing 100 comprises the outer conductive layer 105 or 105′ on the outer surface of the insulating body, the conductive member may be mounted to the outer surface of the insulating body and be in electrical contact with the outer conductive layer 105 or 105′. In the embodiments where the first housing 100 comprises the outer conductive layer 105 or 105′ and an inner conductive layer 104 or 104′ that are respectively on the outer surface and the inner surface of the insulating body and electrically connected, the conductive member may be mounted to the outer surface of the insulating body and be in electrical contact with the outer conductive layer 105 or 105′. This configuration enables more effective full shielding when the cable connector and the board connector are mated.

Optionally, the conductive member may include a conductive contact, conductive foam, conductive resin, or a combination thereof. In one embodiment, the conductive member may be disposed on one face of the first mating end 101. In another embodiment, the conductive member may be disposed on multiple faces of the first mating end 101. In yet another embodiment, the conductive member may surround the first housing 100 in one or more loops.

In the illustrated embodiment, the mating surface may include the outer surface of the first mating end 101. When the cable connector 10 mates with the board connector 20, the shielding shell 23 of the board connector 20 abuts against the conductive member from the outside. In an unillustrated embodiment, the conductive member may be disposed inside the first mating end 101. In this case, when the cable connector 10 mates with the board connector 20, the second mating end 20A of the board connector 20 may be inserted inside the conductive member. The conductive member serves to establish an electrical connection between the first housing 100 and the shielding shell 23 of the board connector 20. The conductive member is designed to not hinder the mating and unmating of the cable connector 10 with the board connector 20, and to provide a reliable electrical connection even after a sufficient number of mating cycles.

In the illustrated embodiment shown in FIGS. 1B and 2, the conductive member may be a conductive ring 300. The conductive ring 300 can be more reliably attached to the first housing 100, and features sufficient contact area and attaching strength to resist detachment from the first housing 100. The conductive ring 300 may be sleeved over the mating end of the housing, e.g., the first mating end 101. In some embodiments where the shielding shell 23 surrounds the second conductive assembly, the conductive ring 300 enables electrical connection in 360 degrees. When the cable connector 10 is subjected to an upwardly directed external force, the conductive ring 300 is in tight contact with the upper portion of the shielding shell 23; when the cable connector 10 is subjected to a downwardly directed external force, the conductive ring 300 is in tight contact with the lower portion of the shielding shell 23. In some embodiments, regardless of the direction in which the external force is applied, at least a section of the conductive ring 300 maintains close contact with the shielding shell 23, ensuring reliable electrical contact.

In some embodiments, the conductive member may be rigid. In some embodiments, the conductive member may be made of a conductive self-lubricating material. During the mating of the cable connector 10 with the board connector 20, the shielding shell 23 of the board connector 20 may undergo elastic deformation under pressure applied by the conductive member, thereby maintaining a certain contact pressure therebetween to avoid poor electrical contact caused by factors such as vibration.

In other embodiments, the conductive ring 300 may be made of an elastic material such as conductive rubber. In these embodiments, the shielding shell 23 may be configured to be rigid to protect the housing of the board connector 20. The conductive ring 300 also can be easily installed onto the first housing 100 by its own elasticity. The elastic conductive ring 300 is easier to process than the elastic shielding shell 23. When the cable connector 10 mates with the board connector 20, the elastic conductive ring 300 can also function as a seal to prevent foreign substances from entering mating interfaces.

As shown in FIGS. 1A-1B and 2, the board connector 20 may include a shielding shell 23, which may serve as at least a portion of the second shielding assembly. The conductive ring 300 is electrically connected between the outer conductive layer 105 or 105′ and the shielding shell 23 when the cable connector 10 mates with the board connector 20. Accordingly, the outer conductive layer 105 or 105′ forms a reliable electrical connection with the shielding shell 23 to achieve fully enclosed shielding.

Optionally, the first housing 100 comprises a recess 180 on its outer surface that surrounds the mounting channel 103 and configured to receive the conductive ring 300. In some embodiments, the conductive ring 300 may be made of conductive rubber. The conductive ring 300 can be substantially flush with the outer surface of the insulating body when mounted into the recess 180. In this way, the cable connector 10 can be inserted into the board connector 20 with minimal resistance, and the conductive ring 300 is unlikely to be damaged. The recess 180 can provide positional restraint to the conductive ring 300, preventing the conductive ring 300 from relative shifting due to friction during the insertion or removal of the cable connector 10 from the board connector 20. In other embodiments, the conductive ring 300 may be made of, for example, a metal material. For instance, an aluminum strip may be pressed into the recess 180 to form the conductive ring 300. In embodiments where the first housing 100 includes a top housing portion 110 and a bottom housing portion 120, a first recess 181 and a second recess 182 may be respectively disposed on the top housing portion 110 and the bottom housing portion 120, and the first recess 181 and the second recess 182 together form an annular recess 180. The conductive ring 300 can further ensure reliable electrical connection between the conductive layers of the top housing portion 110 and the bottom housing portion 120, and reliably establish an electrical connection between the conductive layer of the first housing 100 and the shielding shell 23 of the board connector 20 when the cable connector 10 is inserted into the board connector 20. Additionally, the conductive ring 300 can provide sealing and dust-proofing capabilities. In some embodiments, the engaging force of the projection 111 with the engaging portion 121 can be reduced by means of the strength or elasticity of the conductive ring 300.

Optionally, to further improve the shielding effect, the first shielding assembly further includes a shielding layer 250 on a surface of each of the plurality of flexible flat cables 200. As shown in FIG. 3, as mentioned above, the flexible flat cables 200 each may include a substrate 210, as well as cable conductors 220 and an insulating layer 230 successively formed on a first surface of the substrate 210. At least a portion of the side edges of the flexible flat cable 200 may be free of the cable conductors 220. The at least a portion of the side edges may include the substrate 210, or a combination of the substrate 210 and the insulating layer 230. To further enhance the shielding performance, Optionally, the first shielding assembly further includes a shielding layer 250 on a surface of each of the flexible flat cables 200. Optionally, a shielding layer 250 may be disposed on a second surface of the substrate 210 opposite to the first surface. Optionally, a shielding layer 250 may be disposed on the insulating layer 230. Optionally, a shielding layer 250 may be disposed on both the second surface of the substrate 210 and the insulating layer 230. The shielding layer 250 may electrically isolate from the cable conductors 220 by the substrate 210 or the insulating layer 230. The shielding layer 250 is conductive and flexible, such that it may shield the conductors, with relatively small impacts on the flexibility of the flexible flat cable 200. Optionally, the shielding layer 250 may include a metal sheet, a conductive tape, a metal foil, or a combination thereof. In the embodiment shown in FIG. 3, the shielding layer 250 may be copper foil or aluminum foil. Optionally, the flexible flat cables 200 include a first flexible flat cable 200A and a second flexible flat cable 200B. Each of the first flexible flat cable 200A and the second flexible flat cable 200B may include an inner surface 241 and an outer surface 242 opposite to the inner surface 241, and the inner surface 241 of the first flexible flat cable 200A faces the inner surface 241 of the second flexible flat cable 200B. In the embodiment shown in the figures, the contact pads 270 of the first flexible flat cable 200A and the second flexible flat cable 200B may be disposed on respective outer surfaces 242, so that the contact pads 270 are oriented in opposite directions. When the cable connector 10 mates with the board connector 20, the two groups of conductive terminals of the board connector 20 may press against the contact pads 270 of the first flexible flat cable 200A and the second flexible flat cable 200B in opposite directions, respectively.

Optionally, in the embodiments where the first shielding assembly includes the shielding layer and an inner conductive layer 104 or 104′ on the inner surface of the first housing, the shielding layer may be in electrical contact with the inner conductive layer 104 or 104′, thereby expanding the shielding range and improving electromagnetic compatibility performance.

Optionally, the shielding layer 250 may include an inner shielding layer 251 disposed on the inner surface 241 of at least one of the first flexible flat cable 200A and the second flexible flat cable 200B. The inner shielding layer 251 may extend to the proximal end, e.g., front end, of the corresponding flexible flat cable. In a high-speed, high-density cable connector, the first flexible flat cable 200A and the second flexible flat cable 200B are positioned closer to each other. The inner shielding layer 251 between the first flexible flat cable 200A and the second flexible flat cable 200B can effectively improve signal integrity. Optionally, the first flexible flat cable 200A is configured identically to the second flexible flat cable 200B, such that the flexible flat cables can be standardized for common usage. Optionally, the inner shielding layer 251 may extend along the entire length of the corresponding flexible flat cable. Optionally, the inner shielding layer 251 may cover all the cable conductors 220 of the corresponding flexible flat cable along the width direction. In some embodiments, the inner shielding layer 251 may expose a part of the cable conductors 220 of the corresponding flexible flat cable along the length direction and/or the width direction.

In some usage scenarios, the first flexible flat cable and the second flexible flat cable connected to one cable connector may be respectively connected to electronic devices at different positions, so that the inner surfaces 241 of the first flexible flat cable and the second flexible flat cable are exposed to the outside. The inner shielding layer can prevent external electromagnetic interference from affecting signal transmission and prevent electromagnetic interference from leaking outward. In the case where the first flexible flat cable and the second flexible flat cable are attached together along the entire length of the cable, the inner shielding layer can also prevent crosstalk between signals of the two.

Optionally, the shielding layer 250 may include an outer shielding layer 252 disposed on the outer surface 242 of at least one of the first flexible flat cable 200A and the second flexible flat cable 200B. The outer shielding layer 252 may be electrically connected to the conductive layer of the first housing. The outer shielding layer 252 is spaced apart from the proximal end of the corresponding flexible flat cable 200 to expose the ends of the cable conductors 220 of the corresponding flexible flat cable 200, thereby forming contact pads 270. Accordingly, the shielding performance can be further enhanced. Optionally, in the embodiments where the conductive layers, e.g., the inner conductive layer 104/104′ and the outer conductive layer 105/105′, are disposed on the first housing 100, the conductive layers and the outer shielding layer 252 may have overlapping portions along the length direction of the flexible flat cables 200 to further improve the shielding performance. Optionally, the outer shielding layer 252 may extend backward to the distal end, e.g., rear end, of the corresponding flexible flat cable 200.

However, the present application does not exclude embodiments where the outer shielding layer 252 exposes other portions of the cable conductors 220 of the flexible flat cable 200 along the length direction. Optionally, the outer shielding layer 252 may cover all the cable conductors 220 of the flexible flat cable 200 along the width direction, though embodiments where it leaves portions of the cable conductors 220 uncovered along this width direction are also not excluded. The inner surfaces 241 of the first flexible flat cable 200A and the second flexible flat cable 200B may be attached to each other along the entire length of the cables. In this configuration, even without an inner shielding layer 251, the cables remain unaffected by external electromagnetic interference and do not emit electromagnetic interference externally.

Since the inner surface 241 of the flexible flat cable 200 is free of contact pads 270, the inner shielding layer 251 may extends to the proximal end of the flexible flat cable 200 to shield the contact pads 270. In some embodiments, the inner shielding layer 251 may extend to the area behind the contact pads 270 while remaining electrically isolated from the contact pads 270 by the substrate 210. In some embodiments, the outer shielding layer 252 may extend to a position close to the contact pads 270, and the end of the outer shielding layer 252 may not extend beyond the end of the insulating layer 230 to prevent contact with the contact pads 270.

Accordingly, the shielding layer 250 can wrap the cable conductors of the flexible flat cable 200 as extensively as possible, leaving the contact pads 270 exposed and thereby further improving electromagnetic compatibility performance. Additionally, this design facilitates processing of the flexible flat cable 200. For example, the flexible flat cable 200 with the inner shielding layer 251 and the outer shielding layer 252 can be cut to length, after which the shielding layer 250 and the insulating layer 230 at the end of the inner surface 241 can be peeled away to form the contact pads 270.

The inner shielding layer 251 may be in electrical contact with the outer shielding layer 252. In some embodiments, a flexible flat cable may comprise an opening, through which an inner shielding layer 251 and outer shielding layer 252 of the flexible flat cable may be attached to each other. In other embodiments, multiple flexible flat cables may be arranged along the width direction to form a set of first flexible flat cables or a set of second flexible flat cables, and an inner shielding layer 251 and outer shielding layer 252 of the multiple flexible flat cables may be attached to each other through gaps between the multiple flexible flat cables.

Optionally, at least one section of each of the inner shielding layer 251 and the outer shielding layer 252 is wider than the corresponding flexible flat cable 200, and the inner shielding layer 251 and the outer shielding layer 252 are electrically connected to each other by the widened sections. As shown in FIGS. 3 and 9, sections of the inner shielding layer 251 and the outer shielding layer 252 on the separator 130 may have the same width as the corresponding flexible flat cable 200, so that they can be properly installed onto the separator 130. In some embodiments, for other sections of the flexible flat cable 200 accommodated in the mounting channel 103, the inner shielding layer 251 and the outer shielding layer 252 may be wider than the flexible flat cable 200 to make electrical contact. Optionally, sections of the inner shielding layer 251 and the outer shielding layer 252 outside the first housing 100 may also be wider than the corresponding flexible flat cable 200 for mutual electrical contact, thereby forming a substantially fully enclosed shielding along the entire length of the flexible flat cable 200. This further improves the electromagnetic compatibility performance of the flexible flat cable 200.

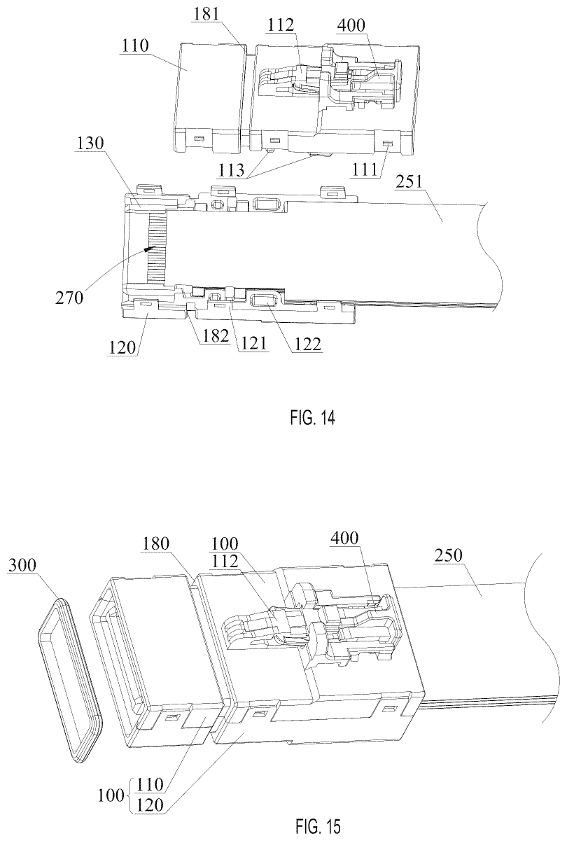

The inner shielding layer 251 and the outer shielding layer 252 may be joined together by welding or adhesive. In some embodiments, the widened sections of the inner shielding layer 251 and the outer shielding layer 252 may be located outside the first housing 100. Optionally, as shown in FIG. 14, the first housing 100, e.g., the top housing portion 110 and the bottom housing portion 120, may include spaces for accommodating the widened sections of the shielding layers 251 and 252. Accordingly, the widened sections of the shielding layers 251 and 252 can extend into the first housing 100, further improving the EMC performance of the cable connector 10.

In some embodiments, conductive layers, such as the inner conductive layer 104/104′ and the outer conductive layer 105/105′, may be formed on both the inner and outer surfaces of the first housing 100 to provide shielding. In some embodiments, the conductive layers may also be in electrical contact with the shielding layers 250 of the flexible flat cables 200 to further enhance electromagnetic compatibility performance. In the embodiment where the widened sections of the inner shielding layer 251 and outer shielding layer 25 extend into the first housing 100, the cable conductors 220 are completely surrounded by the inner shielding layer 251, the outer shielding layer 252 and the conductive layers of the first housing 100 together, effectively avoiding electromagnetic interference.

Optionally, as shown in FIGS. 4A-4B and 13, each flexible flat cable 200 may include a first cable portion 281 positioned on the separator 130, a second cable portion 282 located outside the first housing 100, and a third cable portion 283 joining the first cable portion 281 and the second cable portion 282. The first cable portion 281 and the third cable portion 283 together constitute the end portion of the flexible flat cable 200 within the first housing 100. The aforementioned cable lugs 260 may be disposed on the first cable portion 281. Along the stacking direction, the first housing 100 (excluding the cable lugs 260) is spaced apart from the first cable portion 281 of the flexible flat cable 200. A portion of the mounting channel 103 for accommodating the third cable portions 283 of the flexible flat cables 200 has a size larger than the combined size of the stacked flexible flat cables 200 in the stacking direction. This creates gaps either between the third cable portions or between the third cable portions and the inner wall of the mounting channel 103, such that the first housing 100, such as the top housing portion 110 and the bottom housing portion 120, is prevented from exerting external force to the third cable portions 283. As shown, the first cable portions 281 of the flexible flat cables 200 are fixed by the separator 130 in the stacking direction, while the first housing 100 does not abut against the shielding layers of the flexible flat cables 200, e.g., the outer shielding layer 252. Additionally, the third cable portions 283 of the flexible flat cables 200 are not clamped by the first housing 100. This design effectively prevents the first housing 100 from damaging the cable conductors 220 and/or the shielding layers 250, particularly in applications where the flexible flat cables 200 may be pulled.

As shown in FIGS. 4A-4B, the separator 130 may not run the entire length of the mounting channel 103. Optionally, the separator 130 is disposed in a first channel portion of the mounting channel 103. In some embodiments, at least a part of the second channel portion (at the rear side of the first channel portion) has a size in the stacking direction of the flexible flat cables 200 smaller than the combined size of the end portions of the flexible flat cables 200 and the separator 130. This requires the flexible flat cables to bend as extending from the first channel portion to the second channel portion to fit into the second channel portion. However, the flexible flat cables may have a natural tendency to maintain their original shape as they transition from the first channel portion to the second channel portion. This tendency causes the inner wall of the second channel portion to press against the flexible flat cables, so that the inner conductive layer 104 or 104′ is in electrical contact with the outer shielding layers 252. Optionally, the first housing 100 may comprise strengthening ribs, such as strengthening ribs 150 on the top housing portion 110 and bottom housing portion 120. Referring to FIGS. 6B and 7A, the strengthening ribs 150 comprise first strengthening ribs 151 corresponding to the first channel portion, and second strengthening ribs 152 corresponding to the second channel portion. The second strengthening ribs 152 may protrude beyond the first strengthening ribs 151 toward the interior of the mounting channel. Accordingly, after the top housing portion 110 is snap-fitted with the bottom housing portion 120, the height of the first channel portion defined by the first strengthening ribs 151 may be greater than the height of the second channel portion defined by the second strengthening ribs 152. In this way, the second strengthening ribs 152 can bias the flexible flat cables 200 inward. Although the flexible flat cables 200 are flexible, they still have a certain rigidity, which helps them maintain a naturally straight configuration. Accordingly, the flexible flat cables 200 may have a tendency to abut against the second strengthening ribs 152. In other embodiments not shown, the top housing portion 110 and the bottom housing portion 120 may also have a solid structure, as long as they can bias the flexible flat cables 200 inward.

In the case where an inner conductive layer 104 or 104′ is provided on the inner surface of the first housing 100, the inner conductive layer 104 or 104′ may cover the surfaces of the second strengthening ribs 152. Since the flexible flat cables 200 abut against the second strengthening ribs 152, the shielding layers 250 (such as the outer shielding layers 252) on the flexible flat cables 200 can thus be in electrical contact with the inner conductive layer 104 or 104′ on the second strengthening ribs 152. In this way, the shielding layers 250 of the flexible flat cables 200 can be in electrical contact with the inner conductive layer of the first housing 100. Optionally, the conductive layer (such as outer conductive layer 105 or 105′) of the first housing 100 may be electrically connected to the shielding shell 23 of the board connector 20 through the conductive ring 300, and the shielding shell 23 may be electrically connected to the ground conductor of the first circuit board 30.

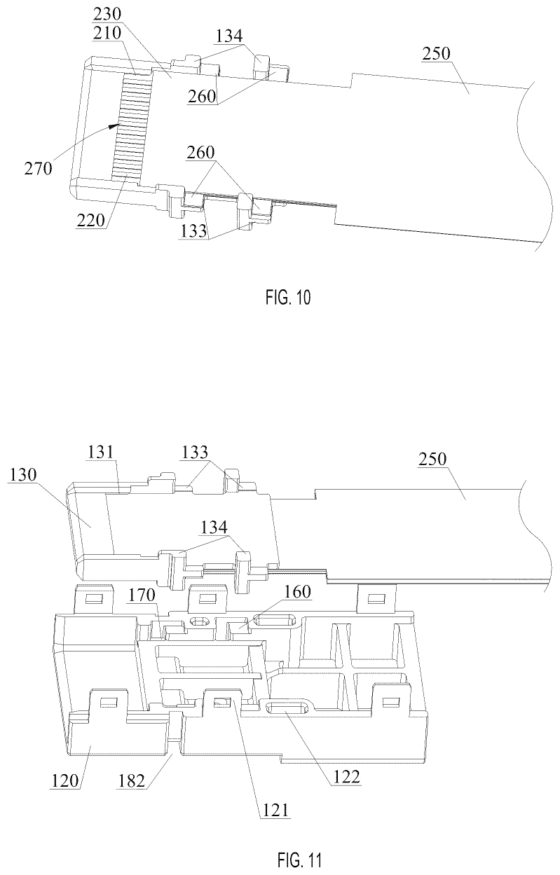

The present disclosure also provides a method for economically assembling an electrical connector. As shown in FIG. 9, the end portion of the first flexible flat cable 200A is to be attached to a first side of the separator 130. Optionally, in the case where the separator 130 includes a plurality of first positioning pins 134 arranged along the length direction of the first flexible flat cable 200A, the separator lugs 133 on the two side edges of the separator 130 may be arranged corresponding to the cable lugs 260. During assembly, the first flexible flat cable 200A can initially be placed on the first side of the separator 130 along the stacking direction, so that the front cable lugs 260 are located between the two first positioning pins 134. After the first flexible flat cable 200A abuts against the first side of the separator 130, the first flexible flat cable 200A can be pushed forward, so that two side edges of the end portion of the first flexible flat cable 200A can be inserted into the opposite first groove 131 and second groove, respectively, as shown in FIG. 10. Accordingly, the cable lugs 260 and the separator lugs 133 can be aligned.

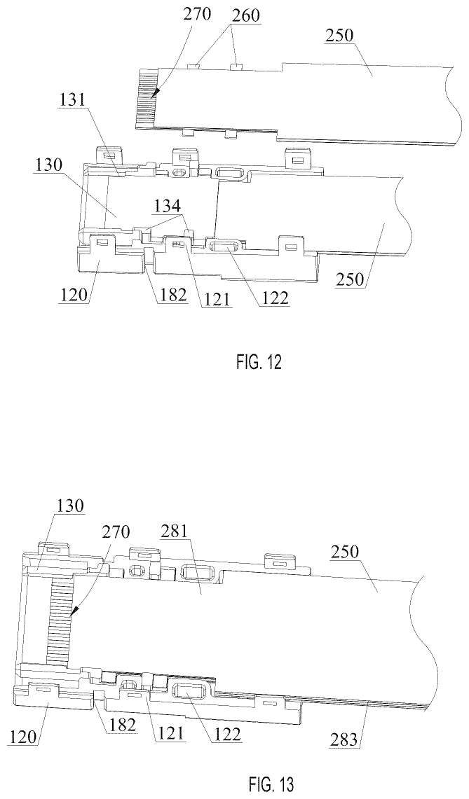

Then, the separator 130 with the first flexible flat cable 200A attached thereto can be assembled to the bottom housing portion 120, as shown in FIG. 11, with the first side of the separator 130 facing the bottom housing portion 120 and the first positioning pins 134 of the separator 130 aligned with the positioning slots 170 of the bottom housing portion 120. After the separator 130 is assembled to the bottom housing portion 120, the cable lugs 260 of the first flexible flat cable 200A can be clamped by the bottom housing portion 120 and the separator 130, and the lug grooves 160 can thus position the first flexible flat cable 200A in the length direction. As mentioned above, the first positioning pins 134 of the separator 130 are inserted into the positioning slots 170 of the bottom housing portion 120, such that the separator 130 can be positioned in both the stacking direction and the length direction. The assembled structure is shown in FIG. 12.

Continuing to refer to FIG. 12, the end portion of the second flexible flat cable 200B is assembled to a second side of the separator 130 opposite to the first side. The second flexible flat cable 200B may be assembled to the second side of the separator 130 in a similar manner to that of the first flexible flat cable 200A. The assembled structure is shown in FIG. 13.

Next, as shown in FIG. 14, the top housing portion 110 is mounted to the bottom housing portion 120. Optionally, the second positioning pins 113 on the top housing portion 110 can be aligned with and then inserted into the positioning holes 122 on the bottom housing portion 120 until the projections 111 on the top housing portion 110 are engaged with the engaging portions 121 on the bottom housing portion 120. Accordingly, the separator 130, the first flexible flat cable 200A and the second flexible flat cable 200B can be clamped between the top housing portion 110 and the bottom housing portion 120. This results in a relatively simple assembly process for the connector, with low assembly costs.

In the above steps, the bottom housing portion 120 is assembled first, and then the top housing portion 110 is assembled. In other embodiments, the top housing portion 110 may be assembled first, followed by the bottom housing portion 120. In some embodiments, the housing with the connector position assurance 400 mounted thereon may specifically be referred to as the top housing portion. For example, the top housing portion may include a first locking feature 112 configured to interact with the connector position assurance 400.

Optionally, after the top housing portion 110 and the bottom housing portion 120 are assembled, the conductive ring 300 can also be sleeved onto the top housing portion 110 and bottom housing portion 120.

Hereinafter, the board connector 20 that mates with the cable connector 10 is described in more detail. As shown in FIGS. 16 and 17, the board connector 20 may include a second housing and a second conductive assembly 22 held by the second housing. The second housing may comprise a main housing 21 and an outer housing 24, with the second conductive assembly 22 held by the main housing 21. Optionally, the second conductive assembly 22 may include a plurality of conductive terminals. The plurality of conductive terminals may be fixed together by a holding member 25, which may be snap-fitted into the main housing 21 to secure the plurality of conductive terminals. The holding member 25 may be insulating. Optionally, in other embodiments, the plurality of conductive terminals may alternatively be directly held by the main housing 21.

Optionally, the board connector 20 may include a second shielding assembly, which may surround at least a part of the main housing 21. The outer housing 24 of the second housing may be disposed outside the second shielding assembly. The outer housing 24 may comprise a second locking feature for locking with the cable connector. The second shielding assembly comprise a shielding shell 23 held between the main housing 21 and the outer housing 24. The shielding shell 23 may circumferentially surround the main housing 21, thereby enclosing the second conductive assembly 22. The board connector 20 is used to establish an electrical connection between a target circuit board, e.g., the first circuit board 30 (also referred to as “first printed circuit board” or “first PCB”), and a complementary electrical connector, e.g., the aforementioned cable connector 10. When the first mating portion of the cable connector 10 is inserted into the board connector 20, electrical interconnection is established between the cable connector 10 and the target circuit board via the board connector 20.

The main housing 21 may be made from an insulating material. Suitable examples include, but are not limited to, plastic, nylon, liquid crystal polymer (LCP), polyphenylene sulfide (PPS), high-temperature nylon, polyphenylene oxide (PPO), or polypropylene (PP). Portions of the shielding shell 23, the main housing 21 and the outer housing 24 collectively form a second mating portion 20A configured to mate with the first mating end 101 of the cable connector 10.

The conductive terminals may be formed from a conductive material. For example, suitable conductive materials for manufacturing the conductive terminals may be a metal or a metallic alloy, such as copper or copper alloy. The conductive terminals each may include an electrical contact end and a mounting end. The electrical contact end may extend to the second mating portion 20A. The electrical contact end may be configured to mate with a corresponding mating portion of a mating electrical component, such as the cable connector 10. The mounting end may extend beyond the second housing and the second shielding assembly. The mounting end may be configured to mount to a circuit board, such as the first circuit board 30. In some embodiments, the first circuit board 30 may include conductive features, such as pads or vias. The mounting ends of the conductive terminals may be configured to connect to the conductive features via any suitable process, e.g., press-fitting or soldering. The conductive terminals each may include a bend joining the electrical contact end and the mounting end, such that the mounting end and the electrical contact end are oriented substantially perpendicular to each other.

Optionally, the main housing 21 may be overmolded onto the conductive terminals. In some embodiments, a holding member 25 may be used in conjunction with the main housing 21 to isolate the mounting ends of the conductive terminals from one another. In some embodiments, the main housing 21 may include a main body and a recess recessed from a mounting surface of the main body. The conductive terminals can be inserted into the main body of the main housing 21 through the recess. Subsequently, the holding member 25 is placed into the recess to secure the mounting ends of the conductive terminals in position.

Optionally, the shielding shell 23 may completely enclose the main housing 21 of the board connector 20 and be connected to signal ground, thereby effectively shielding against external interference. Optionally, the main housing 21 assembled with the second conductive assembly 22 is placed onto a pre-stamped metal sheet, which is then bent to form the shielding shell 23. Optionally, a tongue-and-groove structure may be formed at the lower portion of the shielding shell 23. Originally separate edges of the metal sheet are joined together after bending to withstand forces parallel to the metal sheet. Compared to welding the separate edges of the metal sheet, the tongue-and-groove structure enables rapid mass production via stamping, with lower costs, higher reliability, and better yields.

Since the board connector 20 may withstand tensile forces when mated with the cable connector 10, and the shielding shell 23 serves as the main force-bearing component, increased connection strength between the shielding shell 23 and the first circuit board 30 is required. Optionally, the shielding shell 23 may be soldered to the first circuit board 30. In some embodiments, a surface of the shielding shell 23 may be soldered to the first circuit board 30, thereby forming a reliable connection. Optionally, the shielding shell 23 may include board locks 23A for mounting to the first circuit board 30. Optionally, the board locks 23A may be formed as protrusions from the metal sheet. These protrusions may be inserted into vias and/or through holes of the first circuit board 30 and soldered to further ensure that the shielding shell 23 is firmly locked to the first circuit board 30. The vias 31 of the first circuit board 30 are typically slightly larger than the board locks 23A. When the board locks 23A are inserted into the vias 31, solder may fill the gaps between the board locks 23A and walls of the vias 31, as well as gaps between the board locks and the pads surrounding the vias 31. This securely fixes the shielding shell 23 to the first circuit board 30 while establishing electrical connection to the reference potential in the first circuit board 30, such as ground. This configuration allows for localized heating of the shielding shell 23 and/or the first circuit board 30 during soldering, reducing manufacturing difficulty. During use, forces applied to the shielding shell 23 can be distributed across the first circuit board 30, minimizing the risk of pad separation from the substrate even under force. Preferably, tips of the board locks 23A may have a reduced size, such that the board locks 23A have flanges positioned nearly flush with the lower surface of the shielding shell 23. The slender tips of the board lock 23A facilitate easy insertion into the vias of the first circuit board 30, while the flanges may abut against the first circuit board 30 to position the shielding shell 23 correctly. Optionally, the shielding shell 23 may be fixed to the first circuit board 30 by any other suitable means such as adhesives, features.

The board connector 20 may comprise a second annular cavity between the second shielding assembly and the main housing. The first housing 100 is inserted into the second annular cavity, so that the first shielding assembly is electrically connected to the second shielding assembly. As shown in FIGS. 1B and 17, the outer sidewall of the front portion of the main housing 21 may be spaced apart from the inner sidewall of the shielding shell 23 to form a second annular cavity 27 around the main housing 21. The second annular cavity 27 may receive the first mating end 101 of the cable connector 10. The front portion of the main housing 21 may be inserted into the first mating end 101 of the cable connector 10. Accordingly, the front portion of the main housing 21 may be referred to as the inner layer of the second mating end 20A. The inner layer may be inserted into the first annular cavity 106 between the separator 130 of the cable connector 10 and the first housing 100.

Optionally, along the mating direction, the shielding shell 23 may extend to be flush with the front surface of the main housing 21 facing the cable connector 10, or extend beyond the front surface of the main housing 21, or terminate before it. The shielding shell 23 can protect the cable connector 10 when the board connector 20 mates with the cable connector 10. The shielding shell 23 may withstand larger external forces than either the main housing 21 of the board connector 20 or the first housing 100 of the cable connector 10, thereby preventing unintended disconnection between the cable connector 10 and the board connector 20. The front part of the shielding shell 23 may be sleeved over the outer side of the first housing 100 of the cable connector 10 when the cable connector 10 mates with the board connector 20. Optionally, if a conductive layer is disposed on the surface of the first housing 100, the shielding shell 23 may extend toward the cable connector 10 beyond the front surface of the main housing 21. The shielding shell 23 may reach the position of the conductive ring 300 on the first housing 100, so that the shielding shell 23 is in electrical contact with the conductive layer on the first housing 100 through the conductive ring 300.

The outer housing 24 may surround the shielding shell 23 along the circumferential direction. Optionally, the outer housing 24 may be mounted to the shielding shell 23 by suitable means, such as adhesion, welding, snap-fitting. The outer housing 24 may include a second locking feature 26 that cooperates with the connector position assurance 400 to lock the cable connector 10 and the board connector 20. Optionally, the outer housing 24 may extend forward beyond the shielding shell 23 along the mating direction or be flush with the shielding shell 23, so that the outer housing 24 can surround the first mating end 101 of the cable connector 10. Additionally, the outer housing 24 can lock with the connector position assurance 400 of the cable connector 10 after the cable connector 10 is mated with the board connector 20 to improve the mating reliability. Accordingly, the outer layer of the second mating end 20A of the board connector 20 may be jointly formed by the shielding shell 23 and the outer housing 24.

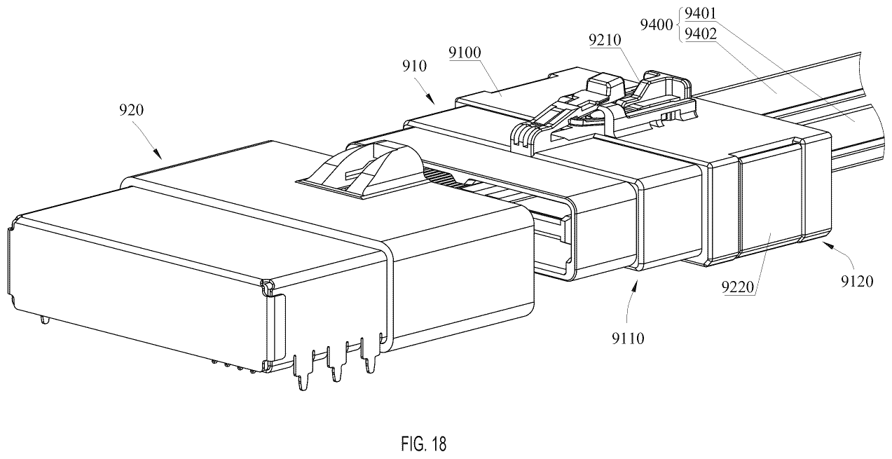

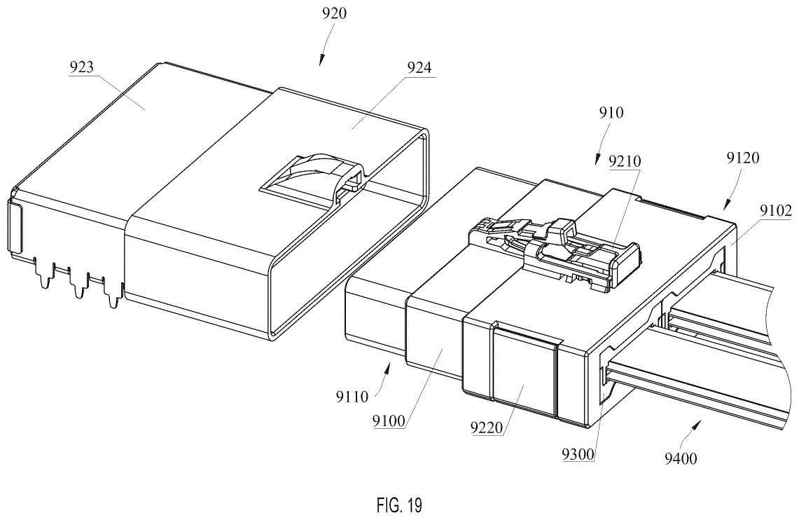

FIGS. 18 and 19 show a part of an electronic system such as that used in an automobile, for interconnecting a plurality of electronic devices in the electronic system. As shown, the electronic system may include a cable connector 910 and a board connector 920 that are mutually mated and detachably connected to each other. The board connector 920 may be mounted onto a circuit board (not shown), such as a first circuit board. The cable connector 910 may include cables. The cable connector 910 may be electrically connected to an electronic device such as another circuit board (e.g., a second circuit board) through the cables, so as to allow a certain distance between the second circuit board and the first circuit board. The cables may include Flexible Flat Cables (FFCs) 9400. The cable connector 910 and the board connector 920 may provide interconnection between the first circuit board and the second circuit board. In some embodiments, the first circuit board with the board connector 920 mounted thereon may be fixed within another electronic device. In harsh environments such as those presented by automobiles, the electronic system may provide transmission of data signals and/or power signals while withstanding vibration.

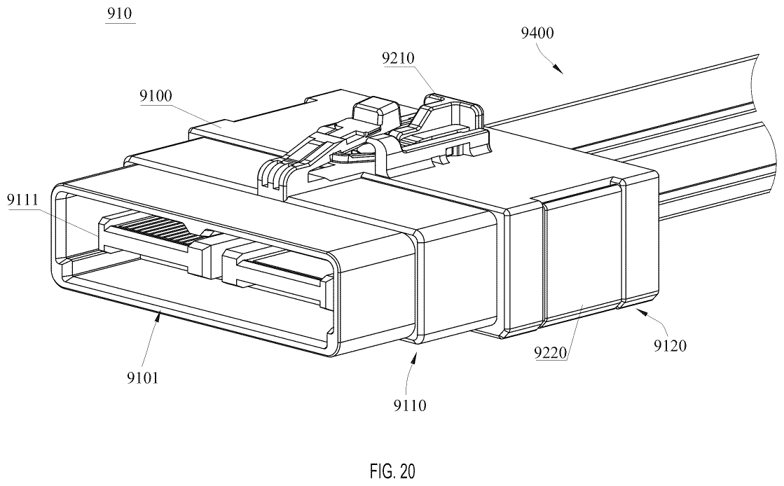

As shown in FIGS. 19 and 20, a connector position assurance 9210 may be mounted on the top of the cable connector 910. Optionally, the connector position assurance 9210 may cooperate with a structure on the top of the cable connector 910 to lock the cable connector 910 with the board connector 920 and prevent accidental separation. The cable connector 910 may include a mating portion 9110 mated with the board connector 920. The mating portion 9110 has a mating surface 9101 facing the board connector 920 (see FIG. 20), which may also be referred to as a front surface. The cable connector 910 may further include a mounting portion 9120. The mounting portion 9120 and the mating portion 9110 may be located at two ends of the cable connector 10. The mounting portion 9120 has a mounting surface 9102, which may also be referred to as a rear surface. In the illustrated embodiment, the mounting surface 9102 is opposed to the mating surface 9101 along the mating direction of the cable connector 910 with the board connector 920. Optionally, the mating surface 9101 is substantially parallel to the mounting surface 9102, so that the end portions of the cables (e.g., the FFCs 9400) within a connector housing 9100 of the cable connector 910 are substantially straight. In an unillustrated embodiment, the mating surface 9101 may be perpendicular to the mounting surface 9102, and the end portions of the FFCs 9400 in the connector housing 9100 may be bent. The FFCs 9400 may be mounted into the connector housing 9100 from the mounting portion 9120 and extend to the mating portion 9110. The FFCs 9400 each may be configured to have at least one contact pad, or electrically connected to at least one contact pad in the connector housing 9100. The at least one contact pad may be located in the mating portion 9110 of the connector housing 9100. The connector housing 9100 may include a mounting channel extending from the mounting portion 9120 to the mating portion 9110 for receiving the FFCs 9400.

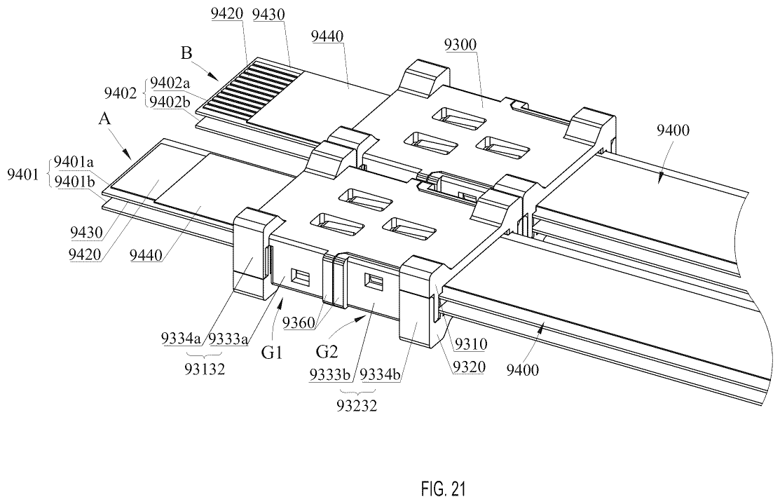

For assembling and replacing the FFCs 9400 easily, the FFCs 9400 may be mounted in the mounting channel of the connector housing 9100 through one or more separate housings 9300. As shown in FIGS. 21-23, an housing 9300 and a group of FFCs 9400 may constitute a cable assembly. The housing 9300 may include a top wall 9311 and a bottom wall 9321. The cable connector 910 may include one or more such cable assemblies. As shown in FIG. 21, two cable assemblies are arranged side by side. Optionally, one group of FFCs 9400 may include first-type FFCs 9401, such as power FFCs; and the other group of FFCs 9400 may include second-type FFCs 9402, such as signal FFCs. The cable assemblies including the first-type FFCs 9401 and the second-type FFCs 9402 are respectively referred to as a first-type cable assembly A and a second-type cable assembly B. Each cable assembly may include a housing 9300. To reduce processing costs, the housings 9300 in different cable assemblies may be designed to be identical or similar in structure. In another embodiment, the multiple groups of FFCs 9400 may be of the same type and used for transmitting, for example, high-speed data signals, low-speed data signals, or power.

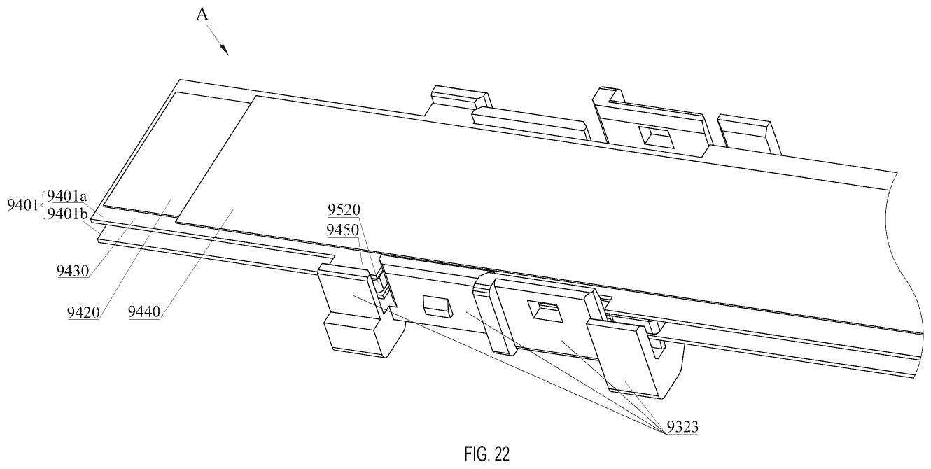

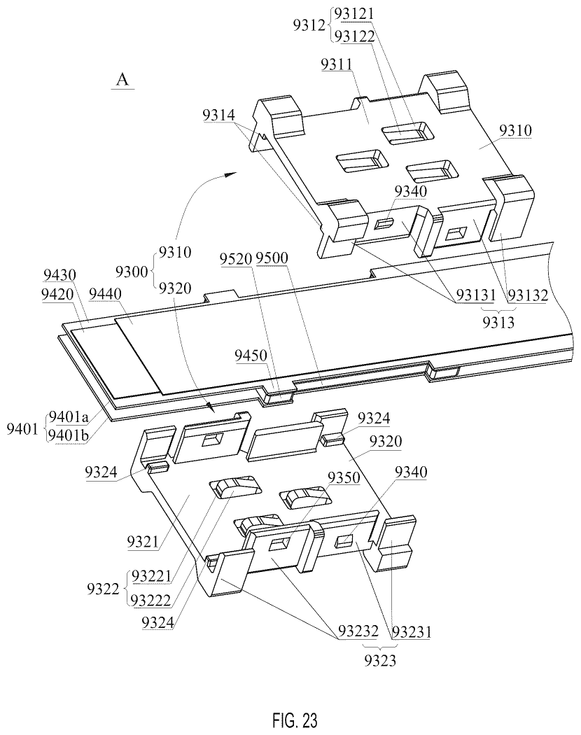

FIG. 22 shows a perspective view of the first-type cable assembly A with a part of the housing removed. FIG. 23 shows an exploded view of the first-type cable assembly A. The principle of embodiments of the present application is described herein by taking the first-type cable assembly A as an example. As shown in FIGS. 22 and 23, the first-type FFCs 9401 in the first-type cable assembly A may include a first FFC 9401a and a second FFC 9401b which are stacked. The end portions of the first FFC 9401a and the second FFC 9401b may be fixed in the connector housing 9100 through the housing 9300. The tail of each of the end portions may include at least one contact pad 9420 for making electrical contact with at least one terminal of the board connector 920 when the cable connector 10 is mated to the board connector 920. The at least one contact pad 9420 is electrically connected to at least one cable conductor in a corresponding FFC, or formed by at least one cable conductor in the corresponding FFC. With reference back to FIG. 21, the first-type FFCs 9401 may have more contact pads 9420 than the second-type FFCs 9402. Optionally, the first-type FFCs 9401 are used for supplying power, and the first-type FFCs 9401 each may comprise one contact pad 9420. Optionally, the second-type FFCs 9402 are used for transmitting signals, and the second-type FFCs 9402 each may comprise a plurality of separate contact pads 9420. The second-type FFCs 9402 may be high-speed/high-density cables.

The end portions of the first FFC 9401a and the second FFC 9401b may be inserted into the housing 9300. The contact pads 9420 may be exposed outside the housing 9300. The housing 9300 may hold the FFCs 9400 by any suitable means, such as clamping, abutting, or bonding. In this way, the cable assembly A is inserted into the connector housing 9100 of the cable connector 910 as a whole, facilitating replacement of the cable assembly A. The first FFC 9401a and the second FFC 9401b are held between the top wall 9311 and the bottom wall 9321 of the housing 9300. Optionally, the housing 9300 may be integrally formed, or optionally, the housing 9300 may include a plurality of separate components that can be assembled together. In some embodiments, the plurality of components may be connected together by ultrasonic welding or adhesives. Optionally, the housing 9300 and the connector housing 9100 may be molded from an insulating material such as plastic. The plastic may include but is not limited to liquid crystal polymer (LCP), polyphenylene sulfide (PPS), high-temperature nylon, poly-p-phenylene oxide (PPO), or polypropylene (PP), or other materials may also be used. In some cases, the plastic may be thermosetting plastic. In some cases, the insulating plastic may include an insulating material reinforced with, for example, glass fibers.

The FFCs may have a relatively low mechanical strength than the housing 9300, and may be easily distorted when subjected to external forces. Accordingly, a supporting portion 9111 is provided in the connector housing 9100 of the cable connector 910, as shown in FIG. 20. Optionally, the supporting portion 9111 may be located in the mating portion 9110. Optionally, the supporting portion 9111 may divide a portion of the mounting channel in the mating portion 9110 into two sub-portions. The FFCs may be inserted in the sub-portions, and abut against the supporting portion 9111. When the cable connector 910 is mated to a complementary connector (e.g., the board connector 920), sufficient pressing force may be exerted by the terminals of the complementary connector to press the FFCs against the supporting portion 9111, enabling reliable contact between the terminals and the contact pads 9420 of the FFCs.

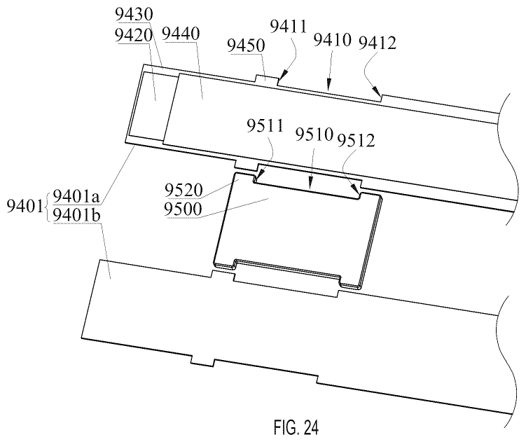

At least the tails of the FFCs 9400 having the contact pads 9420 may be mounted on the supporting portion 9111. After the cable connector 910 is mated to the complementary connector, the supporting portion 9111 may be inserted into the complementary connector. The FFCs 9400 may be clamped by the supporting portion 9111 and the terminals of the complementary connector, enabling reliable electrical contact. As shown in FIG. 24, the first FFC 9401a and the second FFC 9401b of the cable assembly A are stacked. The first surfaces of the first FFC 9401a and the second FFC 9401b respectively have contact pads 9420 and are oriented in opposite directions. The second surfaces of the first FFC 9401a and the second FFC 9401b, which are opposite to the first surfaces, may be respectively attached to different sides of the supporting portion 9111. Optionally, a plurality of supporting portions 9111 may be provided for a plurality of cable assemblies, e.g., the cable assembly A and the cable assembly B, respectively. The plurality of supporting portions 9111 may be arranged in a row along the width direction of the FFCs 9400, and there may be gaps between adjacent supporting portions 9111. The mating portion of the complementary connector may be inserted into the gaps to improve the mechanical strength of the connection between the cable connector 910 and the complementary connector and reduce interference between adjacent cable assemblies. In some embodiments, the gaps between adjacent supporting portions 9111 may also serve to position and mistake-proof for the complementary connector.

Optionally, the cable assembly A may further include a separator 9500. The separator 9500 may be clamped between the first FFC 4901a and the second FFC 9401b. In some embodiments, the two opposite surfaces of the separator 9500 are respectively attached to the second surfaces of the first FFC 9401a and the second FFC 9401b. The contact pads 9420 may be in front of the separator 9500. A gap may be formed between the first FFC 9401a and the second FFC 9401b via the separator 9500 for accommodating the supporting portion 9111. For the flatness of the FFCs 9400, the separator 9500 may have a thickness equivalent to that of the supporting portion 9111 in the connector housing 9100. In the illustrated embodiment, the tails of the FFCs 9400 having the contact pads 9420 are fully attached to the supporting portion 9111, enabling that the contact pads 9420 abut against flat surfaces. Optionally, in other embodiments, the tails of the FFCs 9400 having the contact pads 9420 may instead be at least partially attached to the separator 9500.

In addition, the separator 9500 may also cooperate with the housing 9300 to reliably hold the end portions of the first FFC 9401a and the second FFC 9401b. Optionally, the first FFC 9401a is adjacent to the top wall 9311, and the second FFC 9401b is adjacent to the bottom wall 9321. The first FFC 9401a may be clamped by the top wall 9311 and the separator 9500 at a predetermined position. The second FFC 9401b may be clamped by the bottom wall 9321 and the separator 9500 at a predetermined position. Optionally, the first FFC 9401a and the second FFC 9401b may be fixed to the separator 9500 by any suitable means, such as adhesion. Alternatively or additionally, the first FFC 9401a and the second FFC 9401b are held between the top wall 9311 and the separator 9500, and between the bottom wall 9321 and the separator 9500 respectively, relying on the pressure between the top wall 9311 and the bottom wall 9321. Optionally, at least a part of the separator 9500 may be located in the housing 9300. Furthermore, the separator 9500 may be detachable relative to the housing 9300 to facilitate the assembly of the first FFC 9401a and the second FFC 9401b.

Each of the first FFC 9401a and the second FFC 9401b may have first features on its sides, such as first protrusions 9450 protruding along the width direction of the FFCs, as shown in FIGS. 22-24 and FIGS. 27-28. The first features may be engaged with first adaptive features on the housing 9300. When the first FFC 9401a and the second FFC 9401b are assembled with the housing 9300, the cables can be positioned along the length direction thereof by the housing 9300. Similarly, the separator 9500 may have second features on its sides, such as second protrusions 9520 protruding along the width direction of the FFCs. The second features may be engaged with second adaptive features on the housing 9300 to accurately position the separator 9500 on the housing 9300. Optionally, the first protrusions 9450 and the second protrusions 9520 may be aligned along the length direction of the FFCs respectively. Accordingly, the first and second adaptive feature that engage with a set of aligned first protrusion 9450 and second protrusion 9520 may be configured as a single recess.

Accordingly, the cable assembly can be easily detached from the connector housing 9100 for overall replacement, or the FFCs can be easily removed from the housing of the cable assembly for maintenance or individual replacement of the FFCs.

Optionally, the top wall 9311 may comprise top wall clamping portions protruding toward the first FFC 9401a, and the bottom wall 9321 may comprise bottom wall clamping portions protruding toward the second FFC 9401b. The first FFC 9401a and the second FFC 9401b are clamped between the top wall clamping portions and the separator 9500, and between the bottom wall clamping portions and the separator 9500, respectively, in the stacking direction of the first FFC 9401a and the second FFC 9401b. This design reduces the contact area between the top wall 9311 and the first FFC 9401a, as well as between the bottom wall 9321 and the second FFC 9401b. Consequently, the first FFC 9401a and the second FFC 9401b experience less wear from the top wall 9311 and the bottom wall 9321, respectively. Moreover, the machining accuracy for the top wall 9311 and the bottom wall 9321 can be reduced.

Optionally, as shown in FIGS. 21-24, the first FFC 9401a and the second FFC 9401b each may include a substrate 9430, cable conductors formed on the substrate 9430, and an insulating layer 9440 covering the cable conductors. The substrate 9430 may be insulating. The substrate 9430 typically has both greater thickness and mechanical strength than those of the insulating layer 9440, but has flexibility. The cable conductors may be formed on the substrate 9430 by means of, e.g., adhesion or hot melting. The insulating layer 9440 exposes the cable conductors on the tail of the end portion of the corresponding FFC to form contact pads 9420. The FFCs 9401a and 9401b may have side edges free of cable conductors. These side edges may include the substrate 9430, or a combination of the substrate 9430 and the insulating layer 9440.

The cable conductors on the substrates 9430 of the first-type FFCs 9401 may be fewer in number than the cable conductors on the substrates 9430 of the second-type FFCs 9402, so that the two types of FFCs have different numbers of contact pads 9420. Generally, the cable conductors are in one-to-one correspondence with the contact pads 9420. In some embodiments, the cable conductors may not be equal to the contact pads 9420 in number. In the illustrated embodiment, each of first-type FFCs 9401 includes a single contact pad 9420, and the first FFC 9401a and the second FFC 9401b of the first-type cable assembly A may be electrically connected to the positive electrode and the negative electrode of the power supply respectively.

In an unillustrated embodiment, the first-type FFCs 9401 each may include a plurality of contact pads. Optionally, each of the first FFC 9402a and the second FFC 9402b of the second-type cable assembly B may include a plurality of cable conductors and a plurality of contact pads for transmitting high-speed and/or high-density signals. Accordingly, each of the first FFC 9402a and the second FFC 9402b of the second-type cable assembly B may further include a shielding layer (not shown) covering the insulating layer 9440. The shielding layer may include, but is not limited to, copper foil, aluminum foil, conductive adhesive, etc. The two types of cable assemblies A and B may share features, which may not be repeated.

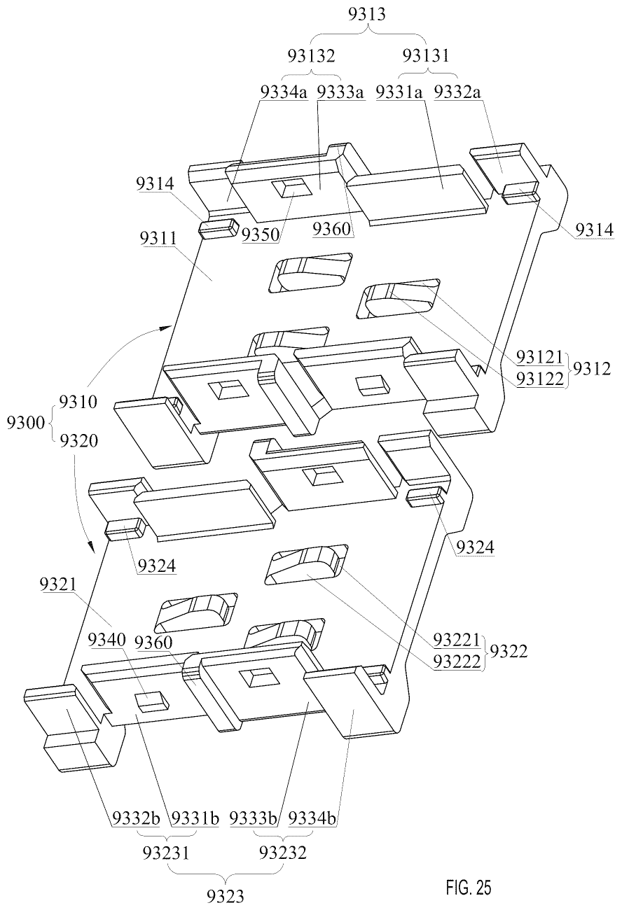

Optionally, as shown in FIGS. 23 and 25, the top wall clamping portions may include first top wall clamping portions 9314. The side edges of the first FFC 9401a are clamped between the separator 9500 and the first top wall clamping portions 9314. The side edges of the first FFC 9401a are free of cable conductors. In this way, the first FFC 9401a can be fixed in place, while the first top wall clamping portions 9314 and the separator 9500 do not apply pressure to the cable conductors. Accordingly, the cable conductors can be prevented from becoming thin or even breaking under large external forces or long-term use.

Optionally, the bottom wall clamping portions may also include first bottom wall clamping portions 9324. The side edges of the second FFC 9401b that are free of cable conductors are clamped between the separator 9500 and the first bottom wall clamping portions 9324. This design can position the second FFC 9401b while avoiding direct pressure on its cable conductors.

Optionally, the first top wall clamping portions 9314 and the first bottom wall clamping portions 9324 are configured to rigidly clamp the first FFC 9401a and the second FFC 9401b. The gaps between the first top wall clamping portions 9314 and the first bottom wall clamping portions 9324 along the stacking direction may be slightly smaller than the combined thickness of the first FFC 9401a, the second FFC 9401b and the separator 9500, enabling the separator 9500 and the two FFCs to be securely held by the housing 9300. Accordingly, the FFCs can be further prevented from being pulled out.

Optionally, the housing 9300 may have two ends opposite to each other along the length direction of the FFCs. Both the first top wall clamping portions 9314 and the first bottom wall clamping portions 9324 are disposed at each of the two ends. The first top wall clamping portions 9314 and the first bottom wall clamping portions 9324 may be aligned along the stacking direction of the first FFC 9401a and the second FFC 9401b. Optionally, both the first top wall clamping portions 9314 and the first bottom wall clamping portions 9324 are disposed on each of two widthwise sides of the first FFC 9401a and the second FFC 9401b. In this way, the housing 9300 clamps the first FFC 9401a, the second FFC 9401b and the separator 9500 at four corners. This allows the cable assembly A to be more compact.

Optionally, as shown in FIGS. 23 and 25-26, the top wall clamping portions may include second top wall clamping portions 9312, and the central portion of the first FFC 9401a is clamped between the separator 9500 and the second top wall clamping portions 9312. The bottom wall clamping portions may further include second bottom wall clamping portions 9322, and the central portion of the second FFC 9401b is clamped between the separator 9500 and the second bottom wall clamping portions 9322. This can further limit the spatial positions of the first FFC 9401a and the second FFC 9401b in the housing 9300.

Optionally, the second top wall clamping portions 9312 and the second bottom wall clamping portions 9322 are configured to exert elastic clamping force on the first FFC 9401a and the second FFC 9401b respectively. This can restrict the motion of the FFCs along the stacking direction, as well as along directions parallel to the plane of the FFCs. The elastic force hardly causes the cable conductors and/or the shielding layer (if present) in the FFCs to deform, such that the signal transmission in the FFCs is less affected. The second top wall clamping portions 9312 and the second bottom wall clamping portions 9322 can effectively absorb impact forces.

Optionally, the second top wall clamping portions 9312 each may include a beam extending from the top wall 9311 and abutting against the first FFC 9401a, and the second bottom wall clamping portions 9322 each may include a beam extending from the bottom wall 9321 and abutting against the second FFC 9401b. In the embodiment shown in FIG. 23, the top wall 9311 may include a plurality of top openings 93121 and a plurality of top beams 93122.

Each of the top beams 93122 may extend from a side of a respective top opening 93121 to an opposed side. The bottom wall 9321 may also include a plurality of bottom openings 93221 and a plurality of bottom beams 93222. Each of the bottom beams 93222 may extend from a side of a respective bottom opening 93221 to an opposed side. These beams 93122 and 93222 may have elasticity. In some unillustrated embodiments, the beams each may be connected to two opposite sides of a respective opening at two ends, even being connected to three or four sides of a respective opening. In other embodiments, the opening may be of other suitable shape, such as a circular shape or an elliptical shape. Optionally, instead, the second top wall clamping portions 9312 and the second bottom wall clamping portions 9322 may be configured as protrusions (not shown) on the top wall 9311 and the bottom wall 9321 respectively. Such a configuration may reduce stress concentrations on the FFCs.

Optionally, the second top wall clamping portions 9312 and the second bottom wall clamping portions 9322 may be located approximately at the middle portions of the housing 9300 along the width direction of the first FFC 9401a and the second FFC 9401b. Taking the top wall 9311 as an example, the top openings 93121 are dispersed in the central area of the top wall 9311, thus enabling the mechanical strength of the top wall 9311 to remain unaffected. As shown in the figures, two of the three second top wall clamping portions 9312 may be arranged in the wider portion of the top wall 9311 along the width direction, and another one may be arranged in the narrower portion of the top wall 9311. This can further avoid the reduction of mechanical strength.

Optionally, the top wall 9311 and the bottom wall 9321 may be separated to two independent parts of the housing 9300. The housing 9300 may include a first housing portion 9310 and a second housing portion 9320. The first housing portion 9310 includes the top wall 9311 and first side walls 9313 extending from the top wall 9311 toward the bottom wall 9321. The first side walls 9313 may be opposite to each other along the width direction of the FFCs. Optionally, the first side walls 9313 may be symmetrically arranged on both sides. Similarly, the second housing portion 9320 may include the bottom wall 9321 and second side walls 9323 extending from the bottom wall 9321 toward the top wall 9311. The second side walls 9323 are opposite to each other along the width direction of the FFCs. Optionally, the second side walls 9323 may be symmetrically arranged on both sides. Continuing to FIG. 23, after the first side walls 9313 are engaged with the second side walls 9323, the side edges of the first FFC 9401a, the second FFC 9401b and the separator 9500 may abut against the first side walls 9313 and the second side walls 9323, such that the first FFC 9401a, the second FFC 9401b and the separator 9500 can be positioned along the width direction of the FFCs. This design enables the cable assembly A to be more compact. As shown, portions of the first side walls 9313 abut against the side edges of the first FFC 9401a, the second FFC 9401b and the separator 9500. The second side walls 9323 may be structurally complementary to the first side walls 9313, and portions of the second side walls 9323 abut against the side edges of the first FFC 9401a, the second FFC 9401b and the separator 9500. The portions of the first side walls 9313 and the portions of the second side walls 9323 may be arranged in sequence or alternately along the length direction of the first FFC 9401a and the second FFC 9401b. Accordingly, the first side walls 9313 together with the second side walls 9323 can fit with the sides of both the first FFC 9401a and the second FFC 9401b. This allows the cables to be constrained throughout the length of the housing 9300.

Optionally, the side edges of each of the first FFC 9401a and the second FFC 9401b are provided with first notches 9410. As shown in FIG. 24, the first notches 9410 may be formed at the side edges of the first FFC 9401a and the second FFC 9401b that are free of cable conductors, for example, the side edges comprise the substrate 9430. The first notches 9410 may be adjacent to the first protrusions 9450. When a plurality of first protrusions 9450 are provided on each side of the first FFC 9401a and the second FFC 9401b, the first notches 9410 may naturally be formed between adjacent first protrusions 9450. At least portions of the first side walls 9313 and the second side walls 9323 are adaptively inserted into the first notches 9410 to limit the positions of the first FFC 9401a and the second FFC 9401b along their length direction. This design allows the structure of the cable assembly A to be simpler.

Optionally, the first side walls 9313 may be engaged with the second side walls 9323 through features, and these features can be conveniently molded integrally with the first housing portion 9310 and the second housing portion 9320 respectively. Also, the first housing portion 9310 and the second housing portion 9320 can be assembled together conveniently and reliably via the features. If the first FFC 9401a and the second FFC 9401b need to be replaced, the features allow the first housing portion 9310 to be conveniently separated from the second housing portion 9320 by using a tool or by hand. In other unillustrated embodiments, the first housing portion 9310 may be connected to the second housing portion 9320 by any suitable means such as ultrasonic welding or bonding.

Optionally, as shown in FIG. 25, the first side walls 9313 may include first inner parts 93131 and first outer parts 93132 arranged along the length direction of the FFCs. The first inner parts 93131 may be spaced apart from the first outer parts 93132. The first inner parts 93131 and the first outer parts 93132 may substantially extend along the entire length of the first housing portion 9310. Both the first inner parts 93131 and the first outer parts 93132 may be symmetrically arranged about an axis of the first housing portion 9310 parallel to the length direction of the FFCs. In the illustrated embodiment, there is a first inner part 93131 and a first outer part 93132 on each side of the first housing portion 9310. In other unillustrated embodiments, there may be a plurality of first inner parts 93131 and/or a plurality of first outer parts 93132 on each side of the first housing portion 9310, in which case the first inner parts 93131 and the first outer parts 93132 may be arranged alternately.

The second side walls 9323 may include second inner parts 93231 and second outer parts 93232 arranged along the length direction. The second inner parts 93231 may be spaced apart from the second outer parts 93232. The second inner parts 93231 and the second outer parts 93232 may substantially extend along the entire length of the second housing portion 9320. Both the second inner parts 93231 and the second outer parts 93232 may be symmetrically arranged about the axis of the second housing portion 9320 parallel to the length direction of the FFCs. In the illustrated embodiment, there is a second inner part 93231 and a second outer part 93232 on each side of the second housing portion 9320. In other unillustrated embodiments, there may be a plurality of second inner parts 93231 and/or a plurality of second outer parts 93232 on each side of the second housing portion 9320, in which case the second inner parts 93231 and the second outer parts 93232 may be arranged alternately.

With reference to FIGS. 25 and 27 in combination, the first inner parts 93131 and the second inner parts 93231 may be staggered along the length direction of the FFCs, and together clamp the first FFC 9401a and the second FFC 9401b along the width direction of the FFCs. The first outer parts 93132 and the second outer parts 93232 may be staggered along the width direction of the FFCs, and clamp the second inner parts 93231 and the first inner parts 93131 along the width direction. In this way, a part of the side walls of the first housing portion 9310 is located inside the side walls of the second housing portion 9320, and a part of the side walls of the second housing portion 9320 is located inside the side walls of the first housing portion 9310. In some embodiments, the first inner parts 93131 of the first housing portion 9310 are clamped by the second outer parts 93232 of the second housing portion 9320, and the second inner parts 93231 of the second housing portion 9320 are clamped by the first outer parts 93132 of the first housing portion 9310. Accordingly, the mechanical strength of the housing 9300 can be increased. Moreover, this design allows the first inner parts 93131 to be connected with the second outer parts 93232 through features; and/or the first outer parts 93132 to be connected with the second inner parts 93231 through features.

Optionally, as shown in FIGS. 25-27, each of the first inner parts 93131 and the second inner parts 93231 includes an inner middle sub-part and an inner end sub-part. The inner middle sub-parts of the first inner parts 93131 and the second inner parts 93231 are inserted in the first notches 9410 on the side edges of the first FFC 9401a and the second FFC 9401b, and the inner end sub-parts of the first inner parts 93131 and the second inner parts 93231 are located outside the first notches 9410. For clarity, the inner middle sub-parts of the first housing portion 9310 are designated by a reference sign 9331a, and the inner end sub-parts of the first housing portion 9310 are designated by a reference sign 9332a. Similarly, the inner middle sub-parts of the second housing portion 9320 are designated by a reference sign 9331b, and the inner end sub-parts of the second housing portion 9320 are designated by a reference sign 9332b. Each of the first outer parts 93132 and the second outer parts 93232 includes an outer middle sub-part and an outer end sub-part. In the illustrated example, the outer middle sub-parts and the outer end sub-parts of the first outer parts 93132 of the first housing portion 9310 are designated by reference signs 9333a and 9334a respectively, and the outer middle sub-parts and the outer end sub-parts of the second outer parts 93232 of the second housing portion 9320 are designated by reference signs 9333b and 9334b respectively. The outer middle sub-parts 9333a and 9333b abut against the outer sides of the inner middle sub-parts 9331b and 9331a respectively, and the outer end sub-parts 9334a and 9334b abut against the outer sides of the inner end sub-parts 9332b and 9332a respectively. In the figure, the inner middle sub-parts 9331b of the second housing portion 9320 abut against the first ends 9411 of the first notches 9410, and the inner middle sub-Attorney parts 9331a of the first housing portion 9310 abut against the second ends 9412 of the first notches 9410. In this way, the first FFC 9401a and the second FFC 9401b are all limited by the housing 9300 along the length direction of the FFCs, to maintain the relative positions of the three (e.g., the first FFC 9401a, the second FFC 9401b, and the separator 9500). The outer middle sub-parts 9333b of the second housing portion 9320 abut against the inner middle sub-parts 9331 a of the first housing portion 9310 inwardly, and the outer end sub-parts 9334b of the second housing portion 9320 abut against the inner end sub-parts 9332a of the first housing portion 9310 inwardly. The outer middle sub-parts 9333a of the first housing portion 9310 abut against the inner middle sub-parts 9331b of the second housing portion 9320 inwardly, and the outer end sub-parts 9334a of the first housing portion 9310 abut against the inner end sub-parts 9332b of the second housing portion 9320 inwardly.

Accordingly, the relative motion of the first housing portion 9310 and the second housing portion 9320 can be restrained, and the structural strength of the housing 9300 is improved. The assembled cable assembly A can have a plurality of substantially flush outer surfaces, such that the cable assembly A can be tightly and reliably held in the connector housing 9100 with no gaps, thus preventing dust accumulation. Additionally, the first FFC 9401a and the second FFC 9401b are prevented from shifting along the width direction of the FFCs, because the inner end sub-parts 9332a, 9332b and the inner middle sub-parts 9331a, 9331b can provide positioning substantially along the entire length of the housing 9300.

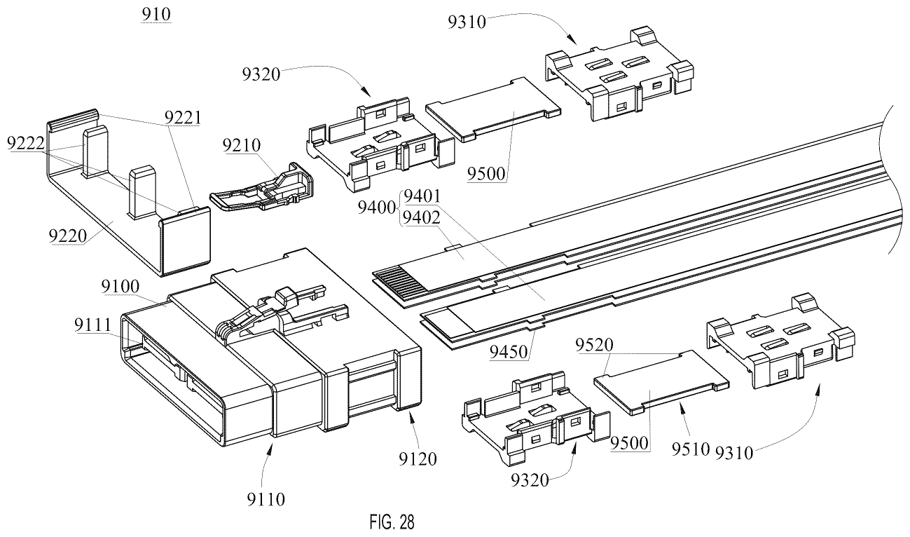

Optionally, ribs 9360 may be provided on the outer surfaces of at least one of the outer middle sub-parts 9333a and 9333b of the first housing portion 9310 and the second housing portion 9320, and the ribs 9360 are spaced apart from corresponding outer end sub-parts, e.g., 9334a and/or 9334b, to form gaps for receiving the terminal position assurance 9220 (see FIGS. 27-28). Optionally, in an embodiment, the ribs 9360 are disposed on the outer middle sub-parts 9333a of the first housing portion 9310 and spaced apart from the outer end sub-parts 9334a to form first gaps G1 for receiving the terminal position assurance 9220, as shown in FIG. 21. Optionally, in another embodiment, the ribs 9360 are disposed on the outer middle sub-parts 9333b of the second housing portion 9320 and spaced apart from the outer end sub-parts 9334b to form second gaps G2 for receiving the terminal position assurance 9220. Optionally, the above two types of ribs 9360 may be provided to form both the first gaps G1 and the second gaps G2. The outer middle sub-parts 9333a and 9333b may be longer to provide sufficient space for the ribs 9360 and the gaps for receiving the terminal position assurance 9220. The cable assembly A can be held in the connector housing 9100 along the length direction of the FFCs through the ribs 9360, thereby preventing the cable assembly A from being detached from the connector housing 9100.

Optionally, features 9340 may be provided on the outer surfaces of at least one of the inner middle sub-parts 9331a and 9331b. Providing the features 9340 on the inner middle sub-parts 9331a, 9331b can also facilitate molding. Correspondingly, openings 9350 may be provided in at least one of the outer middle sub-parts 9333a and 9333b, which also facilitates molding. The first housing portion 9310 is engaged with the second housing portion 9320 through the features 9340 and openings 9350. In the illustrated embodiment, the features 9340 on the first housing portion 9310 are engaged with the openings 9350 on the second housing portion 9320, and the features 9340 on the second housing portion 9320 are engaged with the openings 9350 on the first housing portion 9310. This enables reliable connection between the first housing portion 9310 and the second housing portion 9320.

Optionally, the first inner parts 93131 are symmetrical to the second inner parts 93231 about an axis of the cable assembly A parallel to the width direction of the FFCs. Moreover, the first outer parts 93132 are symmetrical to the second outer parts 93232 about the axis. This can simplify the structure of the housing 9300. Further, the first housing portion 9310 may structurally be identical to the second housing portion 9320. This may reduce production and storage costs, as well as assembly difficulty. Based on this, both the outer middle sub-part 9333a of the first housing portion 9310 and the outer middle sub-part 9333b of the second housing portion 9320 have the ribs 9360, as shown in FIG. 21, so that the first gaps G1 and second gaps G2 can be formed by the two groups of ribs 9360 as well as the outer end sub-part 9334a and the outer end sub-part 9334b. As shown in FIG. 28, the terminal position assurance 9220 may have a pair of first arms 9221, which may have features to be engaged with the connector housing 9100. The terminal position assurance 9220 may further have a plurality of second arms 9222 between the pair of first arms 9221, and the plurality of second arms 9222 may be arranged in a row parallel to the width direction of the FFCs. The second arms 9222 may be inserted into the second gaps G2 between the ribs 9360 on the outer middle sub-part 9333b and the outer end sub-part 9334b of the second housing portion 9320. In other unillustrated embodiments, by offsetting the second arms to the front of the cable connector 10, the second arms may also be inserted into the first gaps G1 between the ribs 9360 on the outer middle sub-part 9333a and the outer end sub-part 9334a of the first housing portion 9310. In some embodiments, two rows of second arms 9222 parallel to the width direction of the FFCs may also be provided to be inserted into the first gaps G1 and the second gaps G2, respectively. The number of second arms 9222 in each row may be related to the number of cable assemblies, such that the cable assemblies can be positioned by the terminal position assurance 9220. In the illustrated embodiment including the first-type cable assembly A and the second-type cable assembly B, three second arms 9222 are in each row. The first gaps G1 and/or the second gaps G2 between the first-type cable assembly A and the second-type cable assembly B may be configured to be engaged with a middle second arm 9222, and the first gaps G1 and/or the second gaps G2 on outsides of the first-type cable assembly A and the second-type cable assembly B may be engaged with the two outer second arms 9222 respectively.

In some embodiments, the first housing portion 9310 may be structurally identical to the second housing portion 9320. In the illustrated example shown in FIG. 25, the left half of the first housing portion 9310 is structurally identical to the right half of the second housing portion 9320, and the right half of the first housing portion 9310 is structurally identical to the left half of the second housing portion 9320. For example, the inner middle sub-part 9331a of the first housing portion 9310 is identical to the inner middle sub-part 9331b of the second housing portion 9320; the inner end sub-part 9332a of the first housing portion 9310 is identical to the inner end sub-part 9332b of the second housing portion 9320; the outer middle sub-part 9333a of the first housing portion 9310 is identical to the outer middle sub-part 9333b of the second housing portion 9320; the outer end sub-part 9334a of the first housing portion 9310 is identical to the outer end sub-part 9334b of the second housing portion 9320. The first housing portion 9310 and the second housing portion 9320 each may be symmetrical about an axis of the housing 9300 parallel to the length direction of the FFCs. In this way, two identical housings (that serve as the first housing portion 9310 and the second housing portion 9320 respectively) can be selected for assembling the housing 9300, and In some embodiments, one is rotated 180 degrees relative to the other and then fastened to the other, to form the housing 9300.

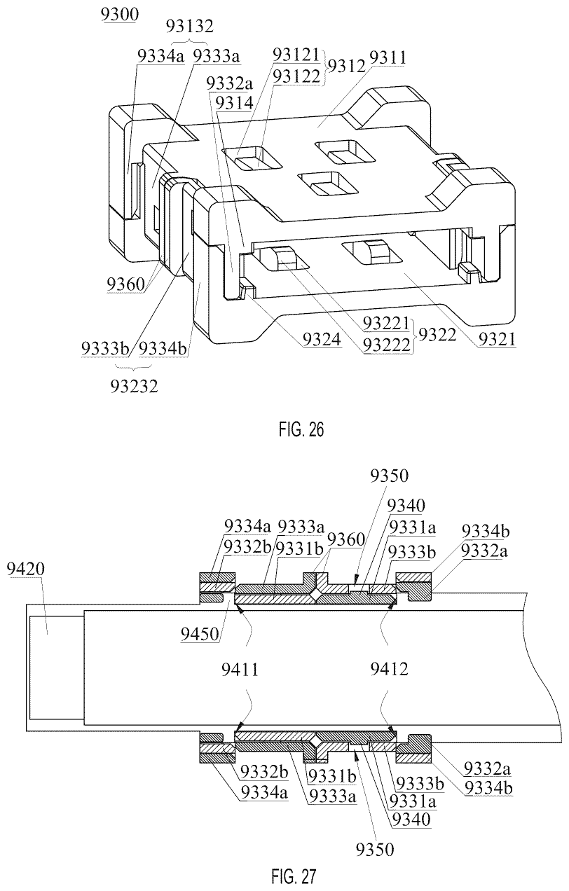

With reference to FIGS. 25 and 26, the first top wall clamping portions 9314 and the first bottom wall clamping portions 9324, which are respectively located at ends of the first housing portion 9310 and the second housing portion 9320 where the inner end sub-parts 9332a and 9332b are provided, may be connected to the inner end sub-parts 9332a and 9332b respectively. The first top wall clamping portions 9314 and the first bottom wall clamping portions 9324, which are respectively located at ends of the first housing portion 9310 and the second housing portion 9320 where the outer end sub-parts 9334a and 9334b are provided, may be spaced apart from the outer end sub-parts 9334a and 9334b respectively to form gaps. These gaps may be dimensioned to accommodate the inner end sub-parts 9332a and 9332b. After assembling, the first top wall clamping portions 9314 of the first housing portion 9310 and the first bottom wall clamping portions 9324 of the second housing portion 9320 may be aligned along the stacking direction of the FFCs and together clamp the FFCs and the separator 9500. For example, the inner end sub-part 9332a of the first housing portion 9310 is clamped between the first bottom wall clamping portions 9324 and the outer end sub-part 9334b of the second housing portion 9320, and the inner end sub-part 9332b of the second housing portion 9320 is clamped between the first top wall clamping portions 9314 and the outer end sub-part 9334a of the first housing portion 9310.

In some embodiments, the first housing portion 9310 may be configured differently from the second housing portion 9320. For example, the ribs 9360 on either the first housing portion 9310 or the second housing portion 9320 may be omitted; or the second top wall clamping portions 9312 and the second bottom wall clamping portions 9322 may be arranged differently, etc.

Optionally, the separator 9500 may comprise second notches 9510 on side edges. As shown in FIGS. 24-25 and 27, at least portions of the first side walls 9313 and at least portions of the second side walls 9323 may be engaged with the second notches 9510 to limit the position of the separator 9500 along the length direction. The second notches 9510 of the separator 9500 have a size close to or equal to that of the first notches 9410 of the first FFC 9401a and the second FFC 9401b. In some embodiments, the second notches 9510 each may have a first end 9511 and a second end 9512, which may be aligned with the first ends 9411 and the second ends 9412 of the first notches 9410 of the first FFC 9401a and the second FFC 9401b respectively. The first side walls 9313 and the second side walls 9323 may abut against the ends of both the first notches 9410 and the second notches 9510 to achieve positioning. In other embodiments, the second notches 9510 of the separator 9500 may have a different shape from the first notches 9410, as long as the separator 9500 can be positioned under the action of the first side walls 9313 and the second side walls 9323.

Optionally, the projections of the side edges of the separator 9500 in a plane parallel to the FFCs coincide with the projections of the side edges of the first FFC 9401a and the second FFC 9401b in the plane. This can provide optimal support for the first FFC 9401a and the second FFC 9401b, while featuring a simpler structure with superior positioning performance.

In some embodiments of the present application, a cable connector 910 is provided, as shown in FIG. 28. The cable connector 910 comprises a connector housing 9100 having a mating portion 9110 and at least one cable assembly held by the connector housing 9100. Each of the at least one cable assembly includes an housing 9300, and a stacked first FFC (e.g., 9401a and/or 9402a) and second FFC (e.g., 9401b and/or 9402b). The tails of the end portions of the first FFC and the second FFC include contact pads 9420 extending to the mating portion 9110 of the connector housing 9100. The housing 9300 surrounds the end portions of the first FFC and the second FFC, with the contact pads 9420 exposed outside the housing 9300. The housing 9300 is held in the connector housing 9100. In some exemplary embodiments, the at least one cable assembly includes a first cable assembly configured for transmitting signals and a second cable assembly configured for supplying power.

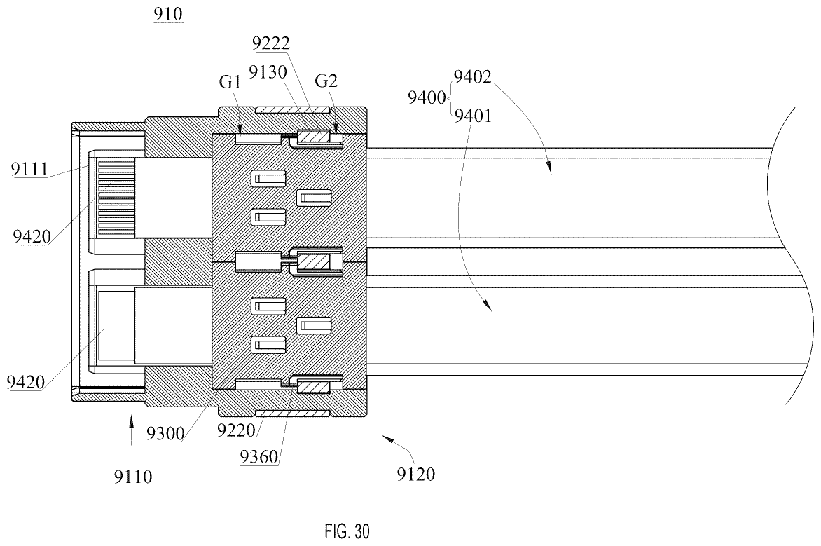

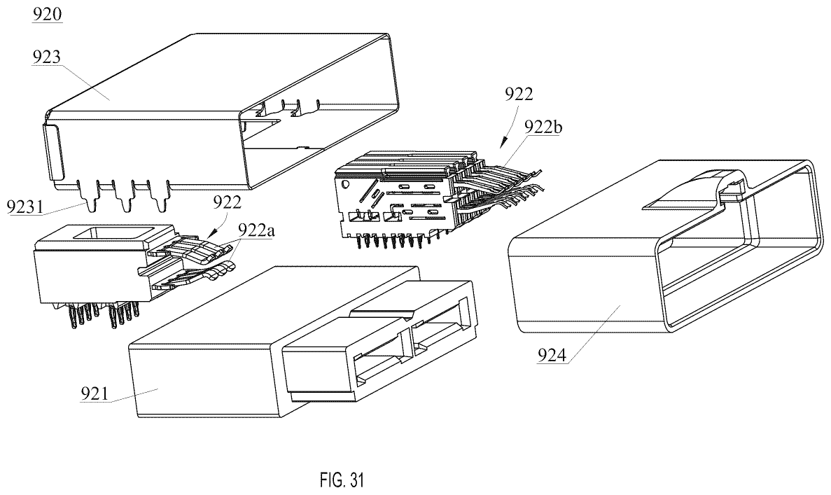

Optionally, as shown in FIG. 30, the connector housing 9100 further includes a mounting portion 9120 opposite to the mating portion 9110 along the length direction of the FFCs, and a mounting channel extending from the mounting portion 9120 into the mating portion 9110. The at least one cable assembly is inserted into the mounting channel from the mounting portion 9120. The inner surface of the mounting portion 9120 may match with the outer surface of the housing 9300 of the at least one cable assembly. Accordingly, the at least one cable assembly can be tightly held by the connector housing 9100. When the cable assembly is inserted into the mounting channel in place in the length direction of the FFCs, the housing 9300 abuts against the mating portion 9110 of the connector housing 9100. The cable connector 910 may further include a terminal position assurance 9220. The terminal position assurance 9220 may be connected to the connector housing 9100 to position the housing 9300 along the length direction together with the mating portion 9110 of the connector housing 9100. The mating portion 9110 and the terminal position assurance 9220 may restrict the position of the housing 9300 in the forward and backward directions, respectively, so that the cable assembly can be secured into the connector housing 9100.

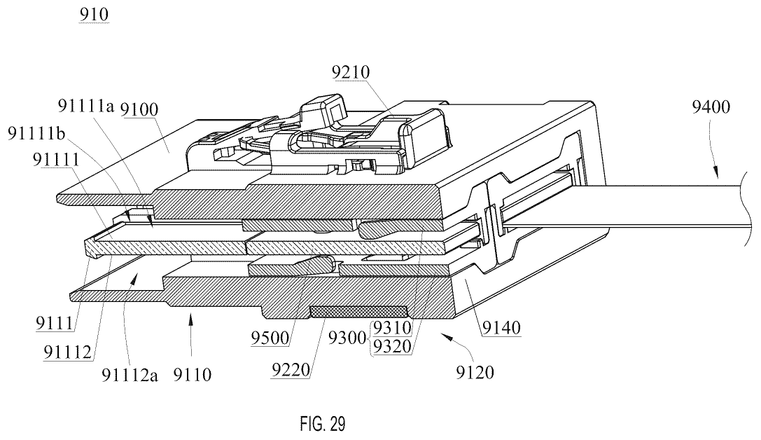

Optionally, the mating portion 9110 may include supporting portions 9111, which may divide a portion of the mounting channel in the mating portion 9110 into two sub-portions, and the sub-portions may respectively accommodate the tails of the first FFCs 9401a and 9402a having the contact pads 9420 and the tails of the second FFCs 9401b and 9402b having the contact pads 9420. As shown in FIG. 29, the supporting portions 9111 each may have a first surface 91111 and a second surface 91112 opposite to each other along the stacking direction of the first FFC 9401a and the second FFC 9401b. A first groove 91111a and a second groove 91112a are recessed from the first surface 91111 and the second surface 91112 respectively.

Taking the first-type cable assembly A for example, the tail of the first FFC 9401a is positioned in the first groove 91111a, and the contact pads 9420 of the first FFC 9401a face the opening of the first groove 91111a. The tail of the second FFC 9401b is positioned in the second groove 91112a, and the contact pads 9420 of the second FFC 9401b face the opening of the second groove 91112a. The depth of the first groove 91111a and the second groove 91112a may be equivalent to or slightly greater than the thickness of the first FFC 9401a and the second FFC 9401b, respectively. When tails of the first FFC 9401a and the second FFC 9401b are inserted into the first groove 91111a and the second groove 91112a respectively, the contact pads 9420 of the first FFC 9401a and the second FFC 9401b are substantially flush with or slightly lower than the respective surfaces of the supporting portion 9111. When the cable connector 10 is mated with the board connector 20, the terminals of the board connector 20 can slide smoothly between the tail of the supporting portion 9111 and the contact pads 9420, thereby avoiding damage to the first FFC 9401a, the second FFC 9401b and/or the terminals.

Optionally, third grooves 91111b may be disposed in a pair of side walls of the first groove 91111a opposite to each other along the width direction of the first FFC 9401a, and the two side edges of the tail of the first FFC 9401a are inserted into the third grooves 91111b respectively. In some embodiments, fourth grooves (not shown) may be disposed in a pair of side walls of the second groove 91112a opposite to each other along the width direction of the second FFC 9401b, and the two side edges of the tail of the second FFC 9401b are inserted into the fourth grooves respectively. In some embodiments, third grooves 91111b or fourth grooves may be provided. The FFCs may warp due to aging, vibration, or internal stress in use, which may cause damage to the FFCs and/or terminals when the cable connector 910 is mated with the board connector 920. The third grooves 91111b and/or the fourth grooves can restrain the warping of the FFCs and prolong the service life.

Optionally, the cable assembly may include a separator 9500 held in the housing 9300 and clamped between the first FFC 9401a and the second FFC 9401b. As shown in FIG. 29, a portion of the supporting portion 9111 between the first groove 91111a and the second groove 91112a has a thickness equal to that of the separator 9500. Accordingly, when the cable assembly A is mounted in the connector housing 9100, the first FFC 9401a and the second FFC 9401b separated by the separator 9500 can enter the first groove 91111a and the second groove 91112a of the supporting portion 9111 respectively, while the side edges of the first FFC 9401a fit into the third grooves 91111b and/or the side edges of the second FFC 9401b fit into the fourth grooves.

Optionally, as shown in FIG. 30, the bottom wall of the connector housing 9100 may comprise mounting holes 9130 communicating with an inner cavity of the connector housing 9100. The outer side surface of the housing 9300 includes gaps extending along the stacking direction of the FFCs, such as the first gaps G1 and/or second gaps G2 mentioned above. The terminal position assurance 9220 is inserted into the first gaps G1 and/or the second gaps G2 through the mounting holes 9130 to position the housing 9300. In the illustrated embodiment, the second arms 9222 of the terminal position assurance 9220 are inserted into the second gaps G2. Moreover, the second gaps G2 are not completely filled by the second arms 9222. Optionally, the second arms 9222 abut against the ribs 9360 in a direction toward the mating portion 9110, to prevent the cable assembly from pulling out. In this way, the processing cost can be lower, the mounting holes 9130 can be smaller, and the mechanical strength of the connector housing is less affected, compared with the embodiment where the second arms 9222 are dimensioned to match with the second gaps G2.

Optionally, as shown in FIG. 29, for each of the at least one cable assembly, the inner surface of the connector housing 9100 may comprise a strengthening rib 9140 extending along the length direction of the FFCs. The strengthening rib 9140 may be embedded in an housing 9300 of a corresponding cable assembly. The strengthening rib 9140 enhances the mechanical strength of the connector housing 9100. Furthermore, the strengthening rib 9140 assists the terminal position assurance 9220 (e.g., the second arms 9222) in positioning the at least one cable assembly along the width direction of the FFCs. This reduces the load on the terminal position assurance 9220, thereby effectively improving the service life and reliability of the cable connector 910.

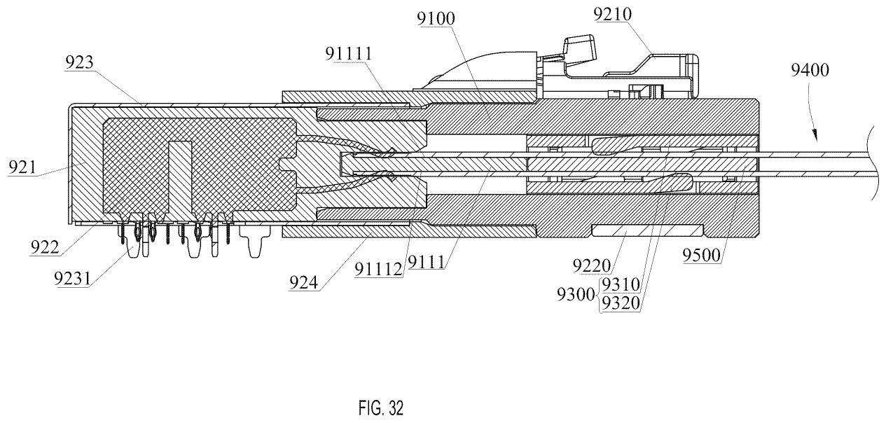

In some embodiments, a board connector 920 is provided. As shown in FIGS. 31 and 32, the board connector 920 may include a housing 921, a plurality of conductive terminals 922, a cage 923, and an outer housing 924. The plurality of conductive terminals 922 are held in the housing 921. Optionally, the plurality of conductive terminals 922 may be held together by a holding member as shown in the illustrated embodiment. The holding member is fixed in the housing 921, so that the plurality of conductive terminals 922 are fixed in the housing 921. The plurality of conductive terminals 922 may include a plurality of first-type conductive terminals 922a and a plurality of second-type conductive terminals 922b. The first-type conductive terminals 922a are electrically connected to the first-type cable assembly A, for example, for supplying power. Optionally, the first-type conductive terminals 922a may match the contact pads 9420 in the first-type cable assembly A in number. Optionally, the first-type conductive terminals 922a may have more mating ends that make electrical contact with the contact pads 9420, for increasing the elasticity of the mating ends. The first-type conductive terminals 922a may be held by a single first holding member, which may be insulating. The second-type conductive terminals 922b are electrically connected to the second-type cable assembly B, for example, for transmitting high-speed/high-frequency signals. Optionally, the second-type conductive terminals 922b may match the contact pads 9420 in the second-type cable assembly B in number. The second-type conductive terminals 922b may be held by a plurality of second holding members, which may be insulating. Optionally, the plurality of second-type conductive terminals 922b may include signal conductive terminals and ground conductive terminals. The ground conductive terminals may be dispersed among the signal conductive terminals. Optionally, conductive or lossy members may be provided in the second holding members to electrically connect adjacent ground conductive terminals. Optionally, the conductive terminals 922 may be directly held in the housing 921. Optionally, the housing 921 may include a plurality of mounting channels, and the conductive terminals 922 are inserted into the mounting channels respectively.

The cage 923 may surround the housing 21 along the circumferential direction of the plurality of conductive terminals 922. The board connector 920 is used to establish an electrical connection between a circuit board (not shown) and a complementary connector (such as the aforementioned cable connector). The circuit board may be a first circuit board (also referred to as a “first printed circuit board” or “first PCB”). The board connector 920 may be mounted on the first circuit board, and the mating portion 9110 of the cable connector 910 may be inserted into the board connector 920, so that an electrical connection is established between the first circuit board and the cable connector 910 through the board connector 920.

The housing 921 may be made of an insulating material. Examples of insulating materials suitable for manufacturing the housing 921 include, but are not limited to, plastic, nylon, liquid crystal polymer (LCP), polyphenylene sulfide (PPS), high-temperature nylon, polyphenylene oxide (PPO), or polypropylene (PP). A portion of the cage 923 and a portion of the housing 921 together form a mating portion for mating with the mating portion 9110 of the cable connector 910. The cage 923 may extend to be flush with the front surface of the housing 921 (e.g., the end surface facing the cable connector 910 along the mating direction), or extend beyond it, or not reach it. The cage 923 can support the mated cable connector 910. The cage 923 can prevent the mating portions of the cable connector 910 and the board connector 920 from being broken by external forces. Optionally, the cage 923 may be fixed to the first circuit board by any suitable means, such as adhesion, soldering, snap-fitting, so as to support and position the housing 921. The cage 923 may be connected to the signal ground to provide effective shielding from external interference.

As best shown in FIG. 31, each of the plurality of conductive terminals 922 may be formed of a conductive material including metal or metal alloy, such as copper or copper alloy. The conductive terminals 922 may include contact ends and mounting ends opposed to contact ends. The contact ends may be configured to electrically connect with an electrical component, such as the cable connector 910, and the mounting ends may be configured to be mounted to a circuit board, such as the first circuit board. In some embodiments, the first circuit board may include conductive parts such as pads or vias, and the mounting ends of the conductive terminals 922 may be configured to be connected to the conductive parts of the first circuit board through any known suitable process (e.g., press-fitting or soldering).

The plurality of conductive terminals 922 may be bent such that the mounting ends and the contact ends are oriented substantially perpendicular to each other.

Optionally, the housing 921 may be overmolded onto the conductive terminals 922. In some embodiments, the housing 921 may further include a mounting assembly (not shown) for spacing the mounting ends of the conductive terminals 922 apart. In some embodiments, the housing 921 includes a body with a recess. When the conductive terminals 922 are mounted into the body, the mounting ends of the conductive terminals 922 are in the recess. Then, adhesive is filled into the recess to secure the mounting ends of the conductive terminals 922.

Optionally, the housing 921 assembled with the conductive terminals 922 is placed onto a metal sheet pre-stamped into a suitable shape, and then the metal sheet is bent into the cage 923. Optionally, edges of the metal sheet may be stamped with tongues and grooves. The edges are joined to each other by engaging the tongues with the grooves after bending, such that the cage 923 can withstand a large force parallel to the metal sheet. Optionally, the tongues and grooves are disposed at the bottom of the cage 923. Compared with welding the edges of the metal sheet, the tongues and grooves can be mass-produced quickly by stamping, with lower cost, higher reliability and yield.

Since the board connector 920 needs to withstand pulling force after being connected to the cable connector 910, the cage 923, which serves as a main force-bearing component, is required to be firmly connected to the first circuit board. Preferably, the cage 923 may be connected to the first circuit board by means of soldering. In some embodiments, the bottom surface of the cage 923 may be soldered to the first circuit board. In a preferred embodiment, the cage 923 may include board locks 9231 for mounting to the first circuit board. The board locks 9231 comprise metallic protrusions, which may be inserted into vias of the first circuit board and then soldered to the first circuit board, thus further enabling the cage 923 to be firmly locked to the first circuit board. The vias are typically slightly larger in size than the board locks 9231.

After the board locks 9231 are inserted through the vias of the first circuit board, solder can be filled into the gaps between the board locks 9231 and the vias to achieve reliable fixation. This configuration allows for localized heating of the cage 923 and/or the first circuit board, reducing soldering difficulty. In use, forces applied to the cage 923 may be distributed across the substrate of the first circuit board, such that the pads are hardly separated from the substrate of the first circuit board. Preferably, tips of the board locks 9231 may have a reduced size, such that the board locks 9231 have flanges nearly flush with the lower surface of the cage 923. The slender tips of the board locks 9231 allows them to be inserted into the vias of the first circuit board easily, and the flanges may abut against the first circuit board to limit the cage 923 to a proper position.

Optionally, the housing 921 may include a front part and a rear part. The front part of the housing 921 and the front part of the cage 923 constitute the mating portion, which may be mated with the mating portion 9110 of the cable connector 910. The rear part of the housing 921 is used to hold the conductive terminals 922. The rear part of the cage 923 may be fixed to the rear part of the housing 921. The rear part of the housing 921 matches with the rear part of the cage 923 in size. The front part of the housing 921 is smaller in size than the front part of the cage 923, so that the inner surface of the front part of the cage 923 is spaced apart from the outer surface of the front part of the housing 921 to form a space for receiving the mating portion 9110 of the cable connector 910. After the cable connector 910 is mated with the board connector 920, the mating portion 9110 of the cable connector 910 may be inserted into the cage 923, and the front part of the housing 921 may be inserted into the mating portion 9110.

The outer housing 924 may surround the cage 923 along the circumferential direction. Optionally, the outer housing 924 may be mounted to the cage 923 by any suitable means, such as adhesion, soldering, snap-fitting. The outer housing 924 may include an adaptive feature for cooperating with the connector position assurance 9210 to lock the cable connector 910 with the board connector 920. Optionally, the outer housing 924 may extend beyond both the cage 923 and the housing 921 toward the cable connector 910, so that after the cable connector 910 is mated with the board connector 920, the outer housing 924 can surround the mating portion 9110 of the cable connector 910 and be locked with the connector position assurance 9210 on the cable connector 910. This design allows for improved mating reliability.

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

In the description of the present disclosure, it is to be understood that orientation or positional relationships indicated by orientation words “front”, “rear”, “upper”, “lower”, “left”, “right”, “lateral direction”, “mating direction”, “perpendicular direction”, “perpendicular”, “horizontal”, “top”, “bottom” and the like usually are shown based on the accompanying drawings, only for the purposes of the ease in describing the present disclosure and simplification of its descriptions. Unless stated to the contrary, these orientation words do not indicate or imply that the specified apparatus or element has to be specifically located, and structured and operated in a specific direction, and Accordingly, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

What is claimed is:

1. An electrical connector comprising:
a housing comprising an insulating body and a conductive layer extending from an inner surface to an outer surface of the insulating body; and
a flexible flat cable comprising a mating portion held in the housing and having one or more contact pads, and a shielding layer spaced from the one or more contact pads and adjacent a portion of the conductive layer on the inner surface of the insulating body of the housing such that the shielding layer of the flexible flat cable is electrically connected to the conductive layer of the housing.

2. The electrical connector of claim 1, comprising:
a conductive member disposed on the housing and adjacent the conductive layer on the outer surface of the insulating body of the housing such that the conductive member is electrically connected to the shielding layer of the flexible flat cable through the conductive layer of the housing.

3. The electrical connector of claim 2, wherein:
the conductive member is elastic.

4. The electrical connector of claim 3, wherein:
the housing comprises a groove recessed from the outer surface; and
the conductive member is disposed in and protrude out of the groove of the housing.

5. The electrical connector of claim 3, wherein:
the conductive member comprises conductive rubber.

6. The electrical connector of claim 1, wherein:
the housing comprises a first inner surface and a second inner surface facing each other;
the flexible flat cable is a first flexible flat cable comprising a first mating portion held in the housing and having one or more first contact pads, and a first shielding layer spaced from the one or more first contact pads and adjacent the conductive layer on the first inner surface of the insulating body of the housing; and
the electrical connector comprises a second flexible flat cable comprising a second mating portion held in the housing and having one or more second contact pads, and a second shielding layer spaced from the one or more second contact pads and adjacent the conductive layer on the second inner surface of the insulating body of the housing.

7. The electrical connector of claim 6, wherein:
the housing comprises a first housing portion and a second housing portion together enclosing a channel; and
the electrical connector comprises a spacer disposed in the channel of the housing and fixedly holding the first mating portion of the first flexible flat cable and the second mating portion of the second flexible flat cable on opposite sides of the spacer.

8. The electrical connector of claim 6, wherein:
the first shielding layer and the second shielding layer comprise aluminum foil.

9. The electrical connector of claim 7, comprising:
a conductive member encircling the channel, and disposed on the housing and adjacent the conductive layer on the outer surface of the insulating body of the housing such that the conductive member is electrically connected to the first and second shielding layers of the first and second flexible flat cables through the conductive layer of the housing.

10. The electrical connector of claim 2, wherein:
the housing comprises a locking feature configured to receive a connector position assurance; and
the conductive member is disposed between the locking feature and the mating portion of the flexible flat cable.

11. An electrical connector comprising:
a connector housing comprising a supporting portion at a mating end; and
at least one cable assembly, each of the at least one cable assembly comprising:
a flexible flat cable comprising a mating portion having one or more contact pads, the mating portion disposed on the supporting portion of the connector housing, and
an assembly housing held in the connector housing and holding the flexible flat cable at a location spaced from the mating portion, the assembly housing comprising one or more beams protruding toward the flexible flat cable.

12. The electrical connector of claim 11, wherein for each of the at least one cable assembly:
the flexible flat cable is a first flexible flat cable comprising a first mating portion having one or more first contact pads;
the cable assembly comprises a second flexible flat cable comprising a second mating portion having one or more second contact pads, and a spacer disposed in the assembly housing and between the first and second flexible flat cables; and
the first and second mating portions are disposed on opposite sides of the supporting portion.

13. The electrical connector of claim 12, wherein:
the assembly housing comprises one or more first beams protruding from a top wall toward the first flexible flat cable, and one or more second beams protruding from a bottom wall toward the second flexible flat cable.

14. The electrical connector of claim 13, wherein:
the one or more first beams and the one or more second beams protrude toward each other.

15. The electrical connector of claim 12, wherein the at least one cable assembly comprises:
a first cable assembly configured for signal transmission; and
a second cable assembly configured for power supply.

16. The electrical connector of claim 15, wherein:
the mating portion of the first flexible flat cable of the first cable assembly comprises a plurality of first contact pads;
the mating portion of the second flexible flat cable of the first cable assembly comprises a plurality of second contact pads;
the mating portion of the first flexible flat cable of the second cable assembly comprises a single third contact pad; and
the mating portion of the second flexible flat cable of the second cable assembly comprises a single fourth contact pad.

17. The electrical connector of claim 12, wherein:
the connector housing comprises an opening at a bottom; and
a terminal position assurance disposed in the opening at the bottom of the connector housing, the terminal position assurance comprises one or more arms extending into the connector housing and engaging the assembly housing of the at least one cable assembly.

18. The electrical connector of claim 17, wherein:
the connector housing comprises a locking feature at a top, the locking feature configured to receive a connector position assurance.

19. An electrical connector comprising:
a main housing;
a plurality of conductive elements held by the main housing;
a cage disposed outside the main housing and comprising a front portion extending beyond the main housing in a mating direction; and
an outer housing attached to the cage and extending beyond the cage in the mating direction, the outer housing comprising a locking feature configured to engage a complementary locking feature of a mating connector and a connector position assurance.

20. The electrical connector of claim 19, wherein:
the main housing comprises a socket;
the plurality of conductive elements comprise mating contact portions in the socket of the main housing, and contact tails extending out of the main housing and configured to mount to a circuit board; and
a gap between the cage and the main housing, the gap configured to receive a portion of a housing of a mating connector such that the cage is electrically connected to a conductive layer of the housing of the mating connector.
